(19) United States
(12) Patent Application Publication
(10) Pub. No.: US 2022/0164738 A1
(43) Pub. Date: May 26, 2022

(54) METHODS AND SYSTEMS FOR TASK MANAGEMENT USING SYNTACTIC MARKERS IN MESSAGING COMMUNICATIONS

(71) Applicant: LOVETT COMMERCIAL, LLC, Houston, TX (US)

(72) Inventor: Frank Liu, JR., Houston, TX (US)

(21) Appl. No.: 17/514,842

(22) Filed: Oct. 29, 2021

Related U.S. Application Data
(60) Provisional application No. 63/118,379, filed on Nov. 25, 2020.

(51) Int. Cl. G06Q 10/06; H04L 12/58

(52) U.S. Cl. CPC G06Q 10/06311; H04L 51/18

(57) ABSTRACT

Methods, computer program products, computer systems, and the like are disclosed that provide for task management using syntactic markers in messaging communications in an efficient and effective manner. For example, such methods, computer program products, and computer systems can include creating a syntactic marker in a messaging system and associating the syntactic marker and a messaging communication with one another. The messaging system comprises a program management database. The messaging communication is sent via the messaging system. The messaging communication is related to a task of a program. The associating comprises updating program management information for the program. The program management information is maintained in the program management database.

### CROSS REFERENCES TO RELATED APPLICATIONS

This application is related to U.S. Provisional Patent Application No. 63/118,379 entitled “METHODS AND SYSTEMS FOR TASK MANAGEMENT USING SYNTACTIC MARKERS IN MESSAGING COMMUNICATIONS,” filed on Nov. 25, 2020, and having Frank Liu and Roberto M. Ramirez as inventors. The foregoing provisional patent applications are hereby incorporated by reference herein, in its entirety and for all purposes.

### FIELD OF THE INVENTION

The present disclosure relates to program management, and more specifically, to methods and systems for task management using syntactic markers in messaging communications.

### BACKGROUND

Presently, in the area of program management (e.g., project management), the management of projects can be cumbersome and ungainly. Such issues arise, in part, as a result of the many skills, jobs, and so on, which are typically involved in a typical project or other program. Take, for example, a construction project. Numerous professions and trades are involved in the many steps that make up the construction of even a simple structure, to say nothing of the land, materials, and other necessities that go into such construction projects. Further, the communication of such information can include plans such as blueprints, site drainage plans, material delivery schedules, lighting and power schematics, and other such plans and schedules. Further still, modifications to such plans may be necessitated by unforeseen circumstances (e.g., delayed shipments of materials, newly-identified obstacles (whether physical or legal), worker injury, failures in construction, revisions to accommodate customer requests or other changes, and so on).

Often, members of such professions and trades will need to communicate with one another regarding various of these steps, materials, and so on, as well as any changes thereto. Thus, communications may need to be initiated from any one of such participants to any other such participant, leading to an exponential explosion in the number of possible communications as the complexity of the given project increases, particularly with regard to an increasing number of participants. Complicating such scenarios is the fact that not all the participants who may need to receive such information (particularly with regard to changes thereto) may receive the requisite communications, and, conversely, participants who do not need to receive such communications may be inadvertently sent such communications. In light of problems such as those just described, mechanisms and approaches directed to the effective, efficient management of projects and other such programs, particularly with regard to the communications between those involved in such programs, have become increasingly desirable.

### BRIEF DESCRIPTION OF THE DRAWINGS

Embodiments of methods and systems such as those disclosed herein may be better understood, and its numerous objects, features, and advantages made apparent to those skilled in the art by referencing the accompanying drawings.

FIG. 1 is a simplified block diagram illustrating another example of a network architecture, according to methods and systems such as those disclosed herein.

FIG. 2 is a block diagram illustrating an example of a client-server architecture supporting a messaging architecture, according to methods and systems such as those disclosed herein.

FIG. 3 is a block diagram illustrating an example of a messaging architecture, according to methods and systems such as those disclosed herein.

FIG. 4 is a block diagram depicting certain elements and features of a server system and other components of a messaging architecture, according to methods and systems such as those disclosed herein.

FIG. 5 is a block diagram depicting certain features of a web messaging architecture according to methods and systems such as those disclosed herein.

FIG. 6 is a block diagram illustrating an example of a generic server architecture, according to methods and systems such as those disclosed herein.

FIG. 7 is a block diagram illustrating an example of a communication server, according to methods and systems such as those disclosed herein.

FIG. 8 is a block diagram illustrating an example of a inter-system communications architecture, according to methods and systems such as those disclosed herein.

FIG. 9 is a block diagram illustrating an example of a system architecture, according to methods and systems such as those disclosed herein.

FIG. 10 is a block diagram illustrating an example of a syntactic marker task cluster diagram, according to methods and systems such as those disclosed herein.

FIG. 11 is a block diagram illustrating an example of messaging interaction diagram, according to methods and systems such as those disclosed herein.

FIG. 12 is a block diagram illustrating an example of a syntactic marker database system schema, according to methods and systems such as those disclosed herein.

FIG. 13 is a block diagram illustrating an example of messaging tables of a syntactic marker database system such as that described in connection with FIG. 12, according to methods and systems such as those disclosed herein.

FIGS. 14A and 14B are block diagrams illustrating an example of syntactic marker tables of a syntactic marker database system such as that described in connection with FIG. 12, according to methods and systems such as those disclosed herein.

FIG. 15 is a block diagram illustrating an example of log tables of a syntactic marker database system schema such as that depicted in FIG. 12, according to methods and systems such as those disclosed herein.

FIG. 16 is a block diagram illustrating an example of marker tables of a syntactic marker database system such as that described in connection with FIG. 12, according to methods and systems such as those disclosed herein.

FIG. 17 is a flow diagram illustrating an example of a program management and communication process, according to methods and systems such as those disclosed herein.

FIG. 18 is a flow diagram illustrating an example of a client process, according to methods and systems such as those disclosed herein.

FIG. 19 is a flow diagram illustrating an example of a task cluster (TC) information filtering process, according to methods and systems such as those disclosed herein.

FIG. 20 is a flow diagram illustrating an example of a task cluster information sorting process, according to methods and systems such as those disclosed herein.

FIG. 21 is a flow diagram illustrating an example of a task cluster information update process, according to methods and systems such as those disclosed herein.

FIG. 22 is a flow diagram illustrating an example of a server messaging process, according to methods and systems such as those disclosed herein.

FIG. 23 is a flow diagram illustrating an example of a server process, according to methods and systems such as those disclosed herein.

FIG. 24 is a flow diagram illustrating an example of a task creation process, according to methods and systems such as those disclosed herein.

FIG. 25 is a flow diagram illustrating an example of an update performance process, according to methods and systems such as those disclosed herein.

FIG. 26 is a flow diagram illustrating an example of a server task update process, according to methods and systems such as those disclosed herein.

FIG. 27 is a flow diagram illustrating an example of a server task information update process, according to methods and systems such as those disclosed herein.

FIG. 28 is a workflow diagram illustrating an example of a project creation workflow, according to methods and systems such as those disclosed herein.

FIG. 29 is a workflow diagram illustrating an example of a task processing workflow, according to methods and systems such as those disclosed herein.

FIG. 30 is a workflow diagram illustrating an example of a project data intake workflow, according to methods and systems such as those disclosed herein.

FIG. 31 is a workflow diagram illustrating an example of a tag message workflow, according to methods and systems such as those disclosed herein.

FIG. 32 is a workflow diagram illustrating an example of a tag sent message workflow, according to methods and systems such as those disclosed herein.

FIG. 33 is a workflow diagrams illustrating an example of an organization bid processing workflow, according to methods and systems such as those disclosed herein.

FIG. 34 is a workflow diagram illustrating an example of a vendor bid processing workflow, according to methods and systems such as those disclosed herein.

FIG. 35 is a workflow diagram illustrating an example of a bid generation workflow, according to methods and systems such as those disclosed herein.

FIG. 36 is a simplified block diagram illustrating components of an example computer system suitable for implementing embodiments of the present disclosure, according to one embodiment.

FIG. 37 is a simplified block diagram illustrating components of an example computer system suitable for implementing embodiments of the present disclosure, according to one embodiment.

While the present disclosure is susceptible to various modifications and alternative forms, specific embodiments of the present disclosure are provided as examples in the drawings and detailed description. It should be understood that the drawings and detailed description are not intended to limit the present disclosure to the particular form disclosed. Instead, the intention is to cover all modifications, equivalents, and alternatives falling within the spirit and scope of the present disclosure as defined by the appended claims.

### DETAILED DESCRIPTION

The following is intended to provide a detailed description and examples of the methods and systems of the disclosure, and should not be taken to be limiting of any inventions described herein. Thus, because the methods and systems described herein are susceptible to various modifications and alternative forms, it will be appreciated that specific embodiments are provided as examples in the drawings and detailed description. It should be understood that the drawings and detailed description are not intended to limit such disclosure to the particular form disclosed. Instead, the intention is to cover all modifications, equivalents and alternatives falling within the spirit and scope of the appended claims.

### Introduction

Methods and systems such as those described herein provide for task management using syntactic markers in messaging communications. Broadly, the concepts described herein are applicable to the organization of one or more programs (e.g., such as a set of related measures or activities with a particular aim that is to be accomplished). Such can be the case, for example, in the organization of project management communications via chat messaging systems, where syntactic markers are used to cluster information regarding such programs (including projects and their tasks/subtasks) in database clusters in a database system of the messaging system. Such methods and systems provide for the efficient, effective management of such programs, using an intuitive interface that makes such communications not only more effective, but also more user-friendly. Further, by employing structures and constructs such as those described herein, implementation of such concepts can be effected in a manner that facilitates the efficient storage and use of such information (e.g., as by significantly improving access to such information, both in terms of the speed with which such information can be found, as well as the speed with which such information can be accessed). And while the methods and systems described herein are discussed, at points, in terms of their use in a messaging system such as a chat messaging system, it will be appreciated that such methods and systems can be applied in other messaging and communications architectures and provide advantages such as those described herein. Further still, while certain of the examples presented herein are described in terms of one or more tasks, such usage is generic, and is intended to comprehend any program, project, phase, task, subtask, or other such activity, whether in whole or in part, or any division or subdivision thereof, whether part of a program, project, task, or the like, or taken alone.

In so doing, methods and systems such as those described herein provide flexible, efficient, and effective techniques for managing programs such as projects, tasks, subtasks, and the like, for example. There are numerous situations in which, for a variety of reasons, the current state of program management is cumbersome and error-prone, as noted earlier. Methods and systems such as those described herein provide functionality that allows for the effective, efficient management of programs by allowing participants such as members of a project to organize information in an easy, intuitive manner through the use of syntactic markers. Such syntactic markers can be used with descriptors to identify salient information in a readable, organized manner.

Methods and systems such as those described herein can include feature such as the following. In certain embodiments, a program managed using such methods and systems can be one or more programs, each of which include one or more tasks. Each such task can be further divided into one or more subtasks (for which checklists can be created), and so on, as may be advantageous in the given circumstances. Functionality such as that described herein. A critical path representation can be generated using, for example, one or more dependent claim trees and predecessor end dates. Projects can be initiated, in part, by identifying participants (in a group for a given project, e.g.), such as members and collaborators. In certain embodiments, Any participant can create a Project, and identify the members thereof. Further, security and an audit trail can be implemented (e.g., by requiring a participant to provide a photo of themselves in responding to an invitation to join a project or group). Geolocation can be employed by way of allowing a participant to check in at their location.

### Example System Architecture

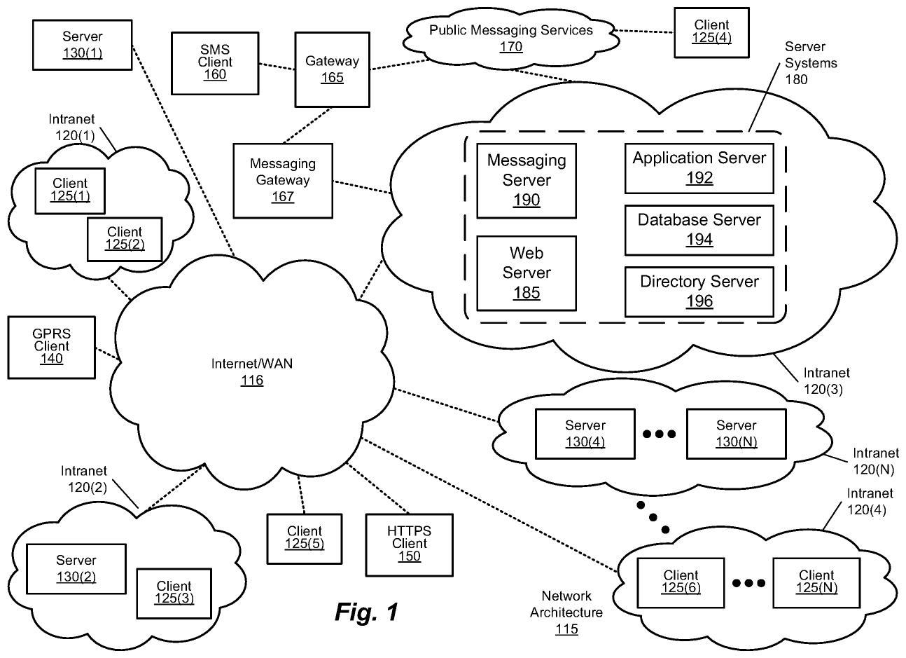

FIG. 1 is a block diagram illustrating an example of a network architecture 115 that includes a server system according to one embodiment. Network architecture 115 includes an internetwork (depicted in FIG. 1 as an internet/wide area network (WAN) 116), which is configured to couple a number of intranets to one another (depicted in FIG. 1 as intranets 120(1)-(N)). Intranets 120(1)-(N), in turn, can include a number of components, such as one or more clients (depicted in FIG. 1 as clients 125(1)-(N)) and/or servers (depicted in FIG. 1 as servers 130(1)-(N)). Clients 125(1)-(N) and/or servers 130(1)-(N) can, for example, be implemented using computer systems such as those described in subsequently. Internet/WAN 116 thus communicatively couples intranets 120(1)-(N) to one another, thereby allowing clients 125(1)-(N) and servers 130(1)-(N) to communicate with one another (and can, in certain embodiments, provide for the servers of intranets 120(3) and 120(N), for example, to operate as cloud-based server systems). As is depicted in FIG. 1, clients 125(1)-(N) can be communicatively coupled to one another and to servers 130(1)-(N) as part of one of intranets 120(1)-(N), or directly via internet/WAN 116. Similarly, servers 130(1)-(N) can be coupled via intranet/WAN 116 via a direct connection to intranet/WAN 116, or as part of one of intranets 120(1)-(N).

Network architecture 115 also provides for communication via intranet/WAN 116 using one or more other devices. Such devices can include, for example, a general packet radio service (GPRS) client 140 (e.g., a “smart phone,” a “tablet” computer, or other such mobile computing system), a secure web client (depicted in FIG. 1 as a secure hypertext transfer protocol client 150), and a basic cellular phone (e.g., using standard texting or other communication protocols, and depicted in FIG. 1 as a simple messaging service (SMS) client 160). HTTPS client 150 can be, for example, a laptop computer using the HTTP Secure (HTTPS) protocol. Support for GPRS clients, SMS clients, HTTP clients, and the like thereby provide users with communication functionality according to an embodiment in a mobile environment. As is also depicted in FIG. 1, SMS client 160 can communicate via internet/WAN 116 via several channels. SMS client 160 can communicate directly, for example, with a gateway 165, which, in turn, communicates with internet/WAN 116 via a messaging gateway 167 and, optionally, elements within intranet 120(3), for example. Alternatively, SMS client 160 can, via gateway 165, communicate with intranet 120(3) (and so, internet/WAN 116) via public messaging services 170 to which gateway 165 and intranet 120(3) are connected. As is also depicted in FIG. 1, a client 125(4) is also able to communicate via internet/WAN 116 by way of public messaging services 170 and intranet 120(3). In order to support such communications, as well as other communications according to various embodiments, intranet 120(3) includes server systems 180, as well as (optionally) providing for a number of clients (not shown), in the manner of intranet 120(2).

Server systems 180 include a number of components that allow server systems 180 to provide various functionalities (e.g., supporting various communications, web-based services, cloud-based services, enterprise services, and so on). Among these components, in certain embodiments, are a number of servers, which can be implemented in hardware and/or software. Server systems 180 includes a number of elements that allow server system 180 to support messaging communications according to embodiments of the present invention. Among these elements are a web server 185, a messaging server 190, an application server 192, a database server 194, and a directory server 196, among other possible such servers, in communication with one another.

Servers such as those included in server systems 180 are designed to include hardware and/or software configured to facilitate functionalities that support operations according to the concepts disclosed herein, among other possible such components and mechanisms, in communication with one another (e.g., directly, via various application programming interfaces (APIs) and/or other such interfaces, and/or other such mechanisms and/or constructs). As will be discussed in greater detail in connection with subsequent figures, the server systems of server systems 180 provide such functionality, for example by presenting end-users with a website (functionality effected by, for example, web server 185). In so doing, such web servers present information collected, generated, organized, and maintained in one or more distributed databases (DDB) by one or more distributed database servers such as database server 194, under the control of one or more application servers. Such a website can be accessed by an end-user using a client computing device such as one or more of clients 125(1)-(N), GPRS client 140, HTTPS client 150, and/or SMS client 160. As will be appreciated in light of the present disclosure, the ability to support such functionality on mobile devices such as those described herein is of importance, as mobile communications and program management are fast becoming an important facet of today's business environment.

As will be appreciated from the foregoing, the letter N is used to indicate a variable number of devices or components. For example, a variable number of clients are implemented in the backup system. Although the letter N is used in describing a variable number of instances of each of these different devices and components, a repeated use of the letter N does not necessarily indicate that each device and component has a same number of N instances implemented in the backup system.

Further, in light of the present disclosure, it will be appreciated that storage devices such as storage devices 160 can be implemented by any type of computer-readable storage medium, including, but not limited to, internal or external hard disk drives (HDD), optical drives (e.g., CD-R, CD-RW, DVD-R, DVD-RW, and the like), flash memory drives (e.g., USB memory sticks and the like), tape drives, removable storage in a robot or standalone drive, and the like. Alternatively, it will also be appreciated that, in light of the present disclosure, backup system 400 and network 405 can include other components such as routers, firewalls and the like that are not germane to the discussion of the present disclosure and will not be discussed further herein. It will also be appreciated that other configurations are possible.

As will be appreciated in light of the present disclosure, processes according to concepts embodied by systems such as those described herein include one or more operations, which may be performed in any appropriate order. It is appreciated that operations discussed herein may consist of directly entered commands by a computer system user or by steps executed by application specific hardware modules, but the preferred embodiment includes steps executed by software modules. The functionality of steps referred to herein may correspond to the functionality of modules or portions of modules.

The operations referred to herein may be modules or portions of modules (e.g., software, firmware or hardware modules). For example, although the described embodiment includes software modules and/or includes manually entered user commands, the various example modules may be application specific hardware modules. The software modules discussed herein may include script, batch or other executable files, or combinations and/or portions of such files. The software modules may include a computer program or subroutines thereof encoded on computer-readable storage media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described in example embodiment are for illustration only. Operations may be combined or the functionality of the operations may be distributed in additional operations in accordance with this disclosure.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagram may be executed by a module (e.g., a software module) or a portion of a module or a computer system user using, for example, a computer system. Thus, the above described method, the operations thereof and modules therefor may be executed on a computer system configured to execute the operations of the method and/or may be executed from computer-readable storage media. The method may be embodied in a machine-readable and/or computer-readable storage medium for configuring a computer system to execute the method. Thus, the software modules may be stored within and/or transmitted to a computer system memory to configure the computer system to perform the functions of the module, for example.

Such a computer system normally processes information according to a program (a list of internally stored instructions such as a particular application program and/or an operating system) and produces resultant output information via I/O devices. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Such a computer system typically includes multiple computer processes executing “concurrently.” Often, a computer system includes a single processing unit which is capable of supporting many active processes alternately. Although multiple processes may appear to be executing concurrently, at any given point in time only one process is actually executed by the single processing unit. By rapidly changing the process executing, a computer system gives the appearance of concurrent process execution. The ability of a computer system to multiplex the computer system's resources among multiple processes in various stages of execution is called multitasking. Systems with multiple processing units, which by definition can support true concurrent processing, are called multiprocessing systems. Active processes are often referred to as executing concurrently when such processes are executed in a multitasking and/or a multiprocessing environment.

The software modules described herein may be received by such a computer system, for example, from computer readable storage media. The computer readable storage media may be permanently, removably or remotely coupled to the computer system. The computer readable storage media may non-exclusively include, for example, any number of the following: magnetic storage media including disk and tape storage media, optical storage media such as compact disk media (e.g., CD-ROM, CD-R, etc.) and digital video disk storage media, nonvolatile memory storage memory including semiconductor-based memory units such as FLASH memory, EEPROM, EPROM, ROM or application specific integrated circuits; volatile storage media including registers, buffers or caches, main memory, RAM, and the like; and other such computer-readable storage media. In a UNIX-based embodiment, the software modules may be embodied in a file, which may be a device, a terminal, a local or remote file, or other such devices. Other new and various types of computer-readable storage media may be used to store the software modules discussed herein.

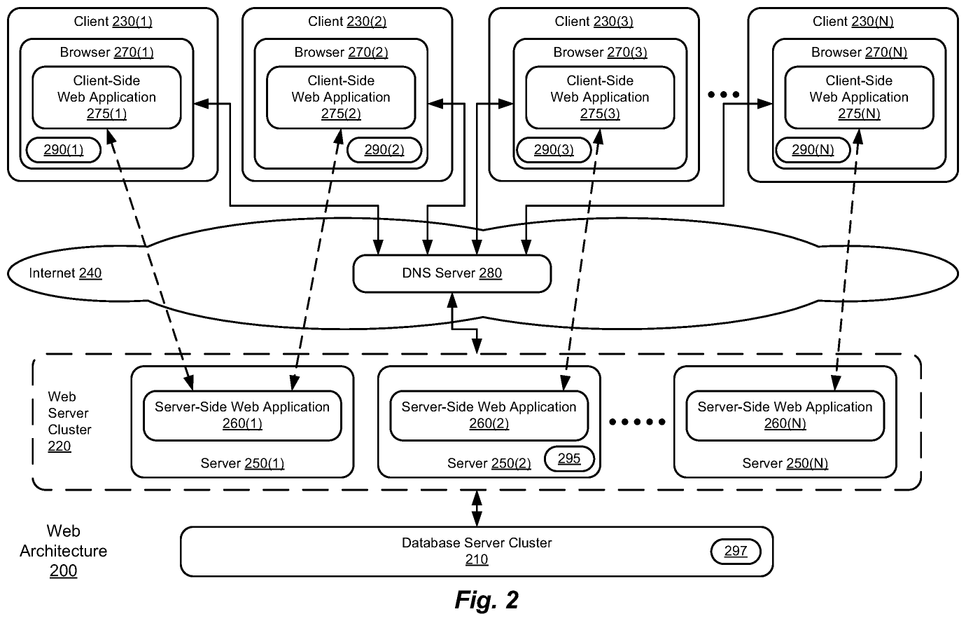

FIG. 2 is a block diagram illustrating an example of a client-server architecture supporting a messaging architecture according to embodiments of the present invention. FIG. 2 depicts a web architecture 200 that includes a database server cluster 210, a web server cluster 220, and a number of clients (depicted in FIG. 2 as clients 230(1)-(N)) communicatively coupled to web server cluster 220 by an internetwork (depicted in FIG. 2 as internet 240). As will be appreciated in light of the present disclosure, a server cluster is a group of independent servers that can be managed as a single system, and so provide higher availability, easier manageability, and greater scalability. In the present scenario, database server cluster 210 is a server cluster providing database facilities, which is architected using clustering techniques. In so doing, database server cluster 210 is able to provide advantages such as load balancing, high availability, and the like, by breaking up the data to be accessed by the servers of web server cluster 220 (e.g., breaking a database into “shards”), by allowing separate data sources to be accessed separately, and so on. Similarly, web server cluster 220 is a group of computer systems executing web server software (e.g., HTTP servers) that collectively provide a web page delivery mechanism, with advantages comparable to those noted above.

In turn, web server cluster 220 includes a number of servers 250(1)-(N), each of which support one or more server-side web applications (depicted in FIG. 2 as server-side applications 260(1)-(N)). As noted, clients 230(1)-(N) access servers 250(1)-(N) via internet 240. More specifically, each of clients 230(1)-(N) support one or more browsers (depicted in FIG. 2 as browser 270(1)-(N), which, in turn, each support one or more client-side web applications (depicted in FIG. 2 as client-side web applications 275(1)-(N)). Each of client-side web applications 275(1)-(N) is configured to communicate with one or more of server-side web applications 260(1)-(N), as is depicted in FIG. 2.

In order to support such communications, browsers 270(1)-(N) can be configured to access one or more servers of web server cluster 220 via internet 240, and more specifically, by accessing a Domain Name System (DNS) server 280. A DNS is a hierarchical, distributed naming system for computers, services, and other resources connected to a network supporting DNS (e.g., the Internet or a private network). A DNS associates various information with domain names assigned to each of the participating entities. For example, browser 220(3) on client 230(3) can access DNS server 280 in order to determine an internet protocol (IP) address of server 250(2). Use of a DNS also allows for load balancing, referred to as DNS balancing.

DNS balancing is an easy and efficient mechanism for implementing a web site that can process more web traffic than might otherwise be the case. DNS balancing involves executing multiple copies of the site on separate physical servers. The DNS server for the hostname of the site is configured to direct access requests such that different access requests are directed to different ones of those servers. This can be accomplished in a number of ways, such as by having the DNS server return more than one internet protocol (IP) address for the hostname (e.g., return multiple IP addresses for the site, from which the requesting browser can choose) or returning a different IP address for each DNS request received, for example. In any event, this results in the distribution of accesses across the web servers of web server cluster 220, although from the perspective of a given one of browsers 270(1)-(N), there is only one web site. Alternative approaches for load balancing include, for example, techniques such as round-robin DNS balancing, hardware-based load balancing, software-based load balancing, reverse proxying, content spreading across hosts, content spreading across outsourced providers, and other such techniques.

Once browser 220(3) is in communication with server 250(2), client-side web application 275(3) is then able to communicate with server-side web application 260(2). In so doing, client-side web application 275(3) and server-side web application 260(2) are able to access information stored in one or more of the databases maintained in database server cluster 210. In certain embodiments, client-side web applications 275(1)-(N) can be implemented as an AJAX client (a client supporting an Asynchronous JavaScript and extensible markup language (XML) (AJAX) framework). AJAX is a group of interrelated web development techniques used on the client-side to create asynchronous web applications. Such client-side web applications can be implemented in JavaScript and extensible markup language (XML) using related web development techniques, including jQuery and Java Script Object Notation (JSON). jQuery is a cross-browser Java Script library designed to simplify the client-side scripting of hypertext markup language (HTML), while JSON is a lightweight, text-base open standard design for human-readable data interchange. On the server side, server-side web applications 260(1)-(N) can be implemented, for example, using any number of approaches for such server-side support (e.g., including Java, C# and .NET, Ruby on Rails, the PHP Hypertext Processor (or more simply, PHP) scripting language, and/or other such technologies, typically some manner of a general-purpose server-side scripting language). As will be discussed subsequently, embodiments of the present invention can take advantage of the aforementioned mechanisms and facilities, in order to provide additional advantages in their implementation.

In the context of a messaging system according to embodiments of the present invention, a web architecture such as web architecture 200 can support various features of such a messaging system using a number of mechanisms. For example, support for the transitioning of messaging sessions between servers can be provided by the maintenance of information (e.g., information maintained on a computer system as a type of “cookie” or other small amount of data, sent from a website and stored for access by a web browser), which is depicted in FIG. 2 as a number of cookies (cookies 290(1)-(N)). Cookies 290(1)-(N) maintain information regarding the state of a given messaging session (or multiple messaging sessions), allowing the messaging session(s) to be passed from one server to another, and thus, facilitating load balancing and failure recovery.

Alternatively, state information for a messaging session can be kept on the server side (e.g., at one of servers 250(1)-(N) (depicted in FIG. 2, e.g., as server-side state information 295)), or maintained in a database used to support the messaging system (e.g., session information can be maintained in a database in database server cluster 210 (depicted in FIG. 2, e.g., as a session information database 297)). Server-side maintenance of messaging session information and management thereof can be managed by a particular server tasked with this responsibility, or can be shared among servers (and/or transferred between servers). Another alternative is to configure the DNS server (e.g., DNS server 280) to manage the messaging sessions by sending accesses to different servers (e.g., the selection of one or more certain URLs/links can be sent to one server, while the selection of other URLs/links are sent to another server; DNS server 280 can be configured to send such accesses to various ones of servers 250(1)-(N) according to a round-robin (or other) scheduling paradigm, or by way of some other comparable mechanism). Clearly, the functionalities provided by a messaging system according to embodiments of the present invention support the implementation of a wide array of features that allow users to communicate in a particularly effective and efficient manner.

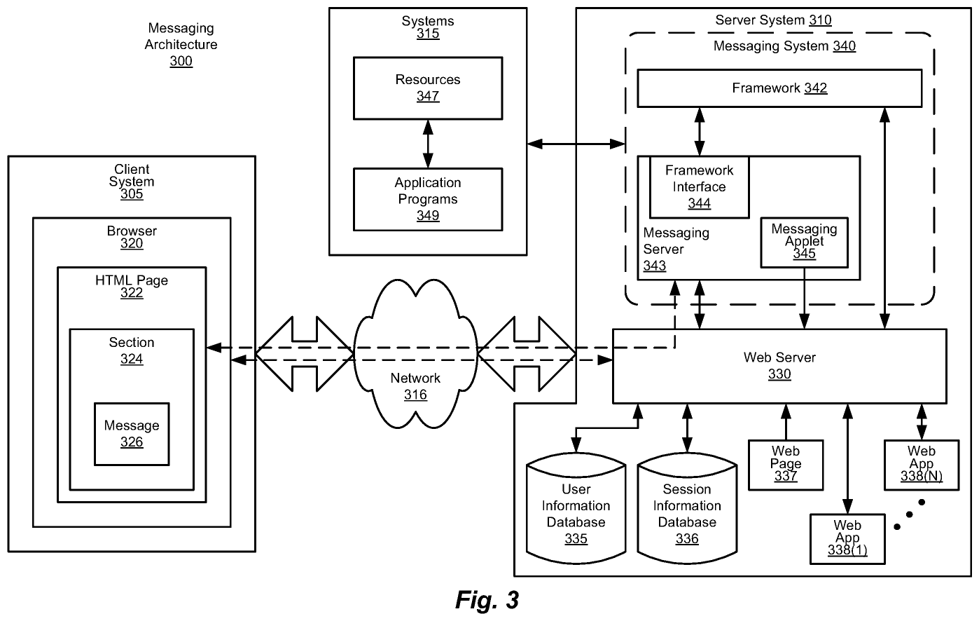

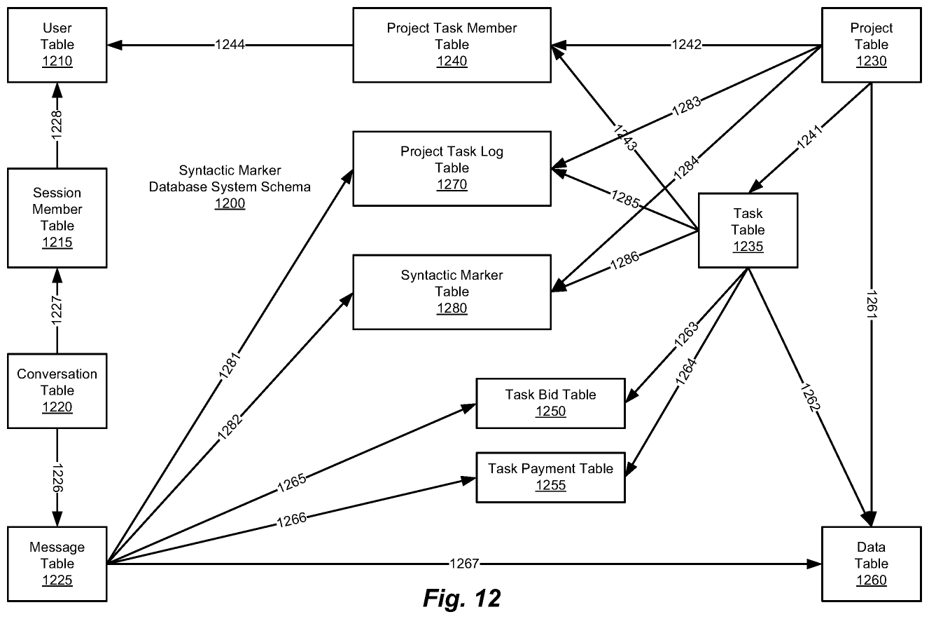

FIG. 3 is a block diagram illustrating an example of a messaging architecture according to embodiments of the present invention (depicted in FIG. 3 as a messaging architecture 300). In the implementation shown in FIG. 3, messaging architecture 300 employs a client-server architecture, such as, generally, that discussed in connection with FIG. 12. Among other elements, messaging architecture 300 thus includes a client system 305 and a server system 310, as well as one or more systems (depicted in FIG. 3 as systems 315). As can also be seen, client system 305 and server system 310 are communicatively coupled to one another by a network 316.

Client system 305 serves as an example of various of the clients depicted in FIG. 1 (e.g., one of clients 125(1)-(N), GPRS client 140, HTTPS client 150, SMS client 160, or other such clients). As part of messaging architecture 300, client system 305 provides support for a browser 320, which is capable of presenting a user with, for example, a page employing a generic markup language or the like (depicted in FIG. 3 as an HTML page 322). HTML page 322, in turn, presents the user with a section 324, and more specifically, a message 326 presented therein. HTML page 322 receives information regarding message 326, for display as part of section 324, from a server within server system 310 via network 316.

Server system 310 can comprehend a number of subsystems, including, for example, a web server 330, a user information database 335, and a session information database 336. Web server 330 is configured to access user information database 335 to obtain user identification information, such as mappings between a user's instant messaging (IM) identifier and their user identifier (e.g., user_id). Similarly, session information database 336 can maintain information such as the messages communicated between users engaged in a messaging session. Server system 310 also provides web server 330 with access to web pages (e.g., depicted in FIG. 3 as a web page 337) and one or more web applications (e.g., depicted in FIG. 3 as web applications 338(1)-(N)).

Server system 310 also provides support for messaging by way of a messaging system 340, to which web server 330 is communicatively coupled. Messaging system 340, in certain embodiments, includes a framework 342 and a messaging server 343. Messaging server 343 is able to communicate with framework 342 via a framework interface 344, and facilitates messaging services by way of supporting the requisite protocols (e.g., Extensible Messaging and Presence Protocol (XMPP)). Similarly, messaging server 343 supports one or more messaging applets (depicted in FIG. 3 as a messaging applet 345). In addition to being able to communicate with web server 330 via various communication paths and mechanisms, messaging system 340 is able to communicate with the elements of systems 315, and more specifically, with the resources (depicted in FIG. 3 as resources 347) and application programs (depicted in FIG. 3 as application programs 349) of systems 315.

Messaging system 340, as noted, is also able to communicate with web server 330 via a variety of communication paths and mechanisms. For example, messaging server 343 can communicate directly with web server 330, as well as doing so by way of its support of messaging applet 345 and the communications between messaging applet 345 and web server 330. Framework 342 can communicate with web server 330 via messaging server 343 using framework interface 344 of messaging server 343, or by communicating with web server 330 directly. In this manner, information from application programs 349 and/or web applications (web apps) 338(1)-(N) can be communicated to and from browser 320 in HTML page 322 via network 316. By way of further example, the output of messaging applet 345 (representing information from application programs 349 and/or web applications 338(1)-(N)) can be conveyed via web server 330, and presented in HTML page 322 as message 326.

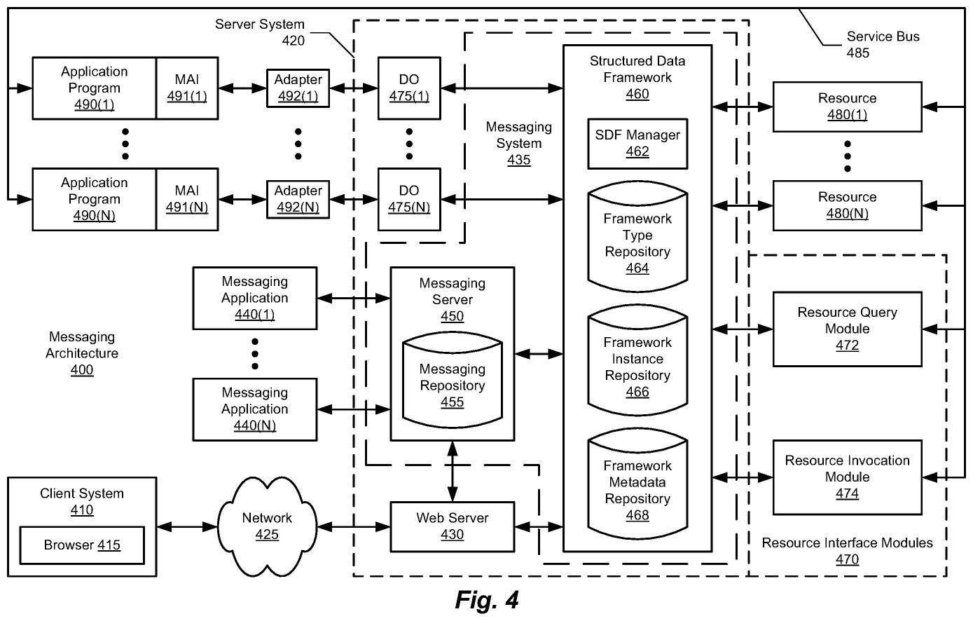

FIG. 4 is a block diagram depicting certain elements and features of a server system and other components of a messaging architecture 400, according to methods and systems such as those disclosed herein. As will be appreciated from the present disclosure, messaging architecture 400 provides greater detail regarding the elements of a server system such as server system 310 with respect to a implementation in which access by (and to) application programs (e.g., in an enterprise) is provided. In the manner of messaging architecture 300, messaging architecture 400 provides a client system 410 that supports a browser 415, and provides browser 415 with access to a server system 420 via a network 425. Server system 420, in the manner of server system 310, supports a number of servers and systems, in order to provide the requisite web services and messaging functionality. Among these elements are a web server 430 and a messaging system 435.

In messaging architecture 400, web server 430 and messaging system 435 provide support for one or more messaging applications that allow messaging communications between users accessing server system 420. Within an enterprise, for example, a user might access server system 420 (and more specifically, messaging system 435) through the use of a messaging application such as one or more of messaging applications 440(1)-(N). In order to support such messaging communications, messaging system 435 includes a messaging server 450, which, in turn, includes a messaging repository 455. Messaging system 435 can also provide for a structured data framework 460, which supports a messaging paradigm that includes the ability to include a syntactic marker in a message-based messaging session. To support such operations, structured data framework 450 includes a structured data framework (SDF) manager 462, a framework type repository 464, a framework instance repository 466, and a framework metadata repository 468, among other such elements.

Server system 420 supports communications with enterprise systems by direct communication, as well as via constructs such as resource interface modules 420 (which include, e.g., a resource query module 472 and a resource invocation module 474) and data objects (DOs) 475(1)-(N). As will be appreciated in light of the present disclosure, messaging system 435 is designed to convey a DO such as one of DOs 475(1)-(N) between an application program and/or a messaging application (e.g., one of messaging applications 440(1)-(N)), and client system 410, via network 425 and web server 430. In so doing, such structured data is conveyed (e.g., in a message) to client system 410, for presentation in a graphical user interface (GUI) in which the message is presented (e.g., browser 415) as a form, for example.

Resource interface modules 470 support communication between SDF 460 and one or more resources (depicted in FIG. 4, e.g., as resources 480(1)-(N)) via a server bus 485. Resource interface module 470 and resources 480(1)-(N) are also able to use service bus 485 to communicate with one or more application programs (depicted in FIG. 4 as application programs 460(1)-(N)). Information from application programs 490(1)-(N) are communicated to data objects 475(1)-(N) via a corresponding one of messaging application interfaces (MAIs) 491(1)-(N) and adapters 492(1)-(N), as illustrated in FIG. 4. By providing both messaging system 435 (and more specifically, structured data framework 460) and application programs 490(1)-(N), messaging architecture 400 is able to allow users of messaging applications 440(1)-(N) and users accessing server system 420 via their browsers (e.g., browser 415), and thereby communicate structured data from one to the other.

Further, messaging functionality is provided in messaging architecture 400, at least in part, by providing messaging system 435 (and more particularly, SDF 460) and application programs 490(1)-(N) (via MAIs 491(1)-(N) and adapters 492(1)-(N)) with access to DOs 475(1)-(N). To this end, as will be appreciated in light of the present disclosure, DOs 475(1)-(N) are depicted in FIG. 4 as being accessed by both SDF 460 and application programs 490(1)-(N). In such a scenario, messaging architecture 400 can provide messaging system 435 and application programs 490(1)-(N) with shared access to DOs 475(1)-(N), for example. In another embodiment, messaging system 435 and application programs 490(1)-(N) can alternate accessing DOs 475(1)-(N) under the control of SDF 460 or on “a first come, first served” basis, for example. In fact, any one of a number of methods can be used to provide SDF 460 and application programs 490(1)-(N) with access to DOs 475(1)-(N). Alternatively, DOs 475(1)-(N) can be passed between messaging system 435 and application programs 490(1)-(N). The foregoing alternatives, as well as other alternatives comparable thereto, are intended to come within the scope of the present disclosure, which is therefore intended to comprehend such alternatives.

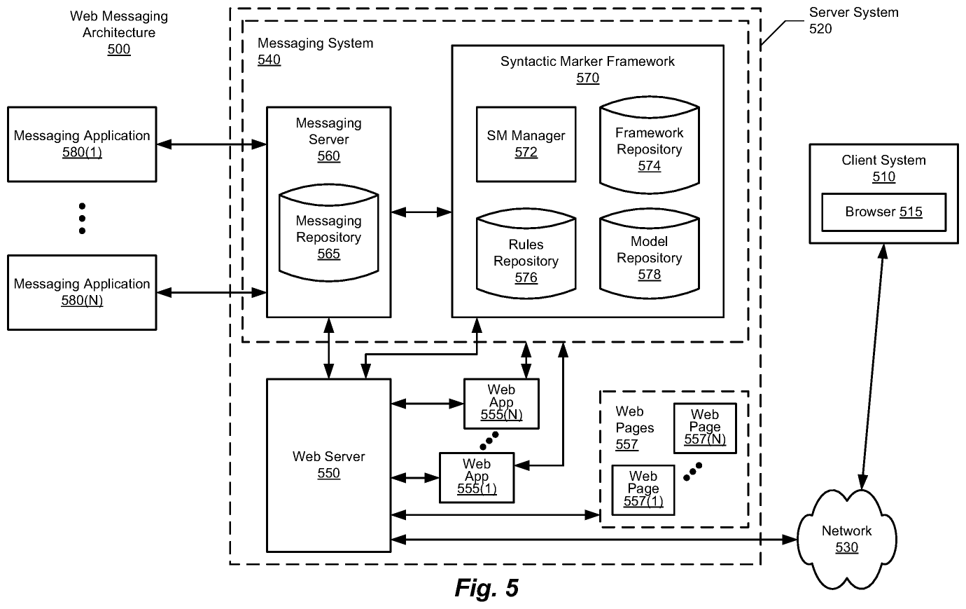

FIG. 5 is a block diagram depicting certain features of a web messaging architecture according to methods and systems such as those disclosed herein, including features of a server system and other elements of such a web messaging architecture. A web messaging architecture 500, including various elements thereof, is thus depicted. As will be appreciated from the present disclosure, web messaging architecture 500 shows, in greater detail, an architecture that includes elements of a server system such as those described earlier herein, with respect to an implementation in which messaging functionality according to embodiments of the present invention is provided to one or more web applications. Thus, in the manner of messaging architecture 300, web messaging architecture 500 provides support for conducting messaging communications between a client system 510 (which, in turn, supports a browser 515) and a server system 520, via a network 530. As depicted in FIG. 5, server system 520 includes a messaging system 540 and a web server 550. Associated with web server 550 are a number of web applications (depicted in FIG. 5 as web applications (web apps) 555(1)-(N)) and one or more web pages (depicted in the aggregate in FIG. 5 as web pages 557, and individually, as web pages 557(1)-(N)). Messaging system 540, in turn, includes a messaging server 560 (which maintains information relevant to the one or more messaging sessions supported thereby, in a messaging repository 565) and a syntactic marker framework 570. Syntactic marker framework 570, in turn, includes a syntactic marker framework (SMF) manager 572, a framework repository 574, a rules repository 576, and a model repository 578. Communicatively coupled to server system 520, and more particularly messaging server 560, are a number of messaging applications (depicted in FIG. 5 as messaging applications 580(1)-(N)).

As will be appreciated from discussions elsewhere herein, at least certain of the functionality provided by SM manager 572, framework repository 574, rules repository 576, and model repository 578 is comparable to that of comparable elements depicted therein. However, given that web messaging architecture 500 supports syntactic markers, SM manager 572, framework repository 574, rules repository 576, and model repository 578 provide additional functionality that supports the dynamic nature of syntactic markers.

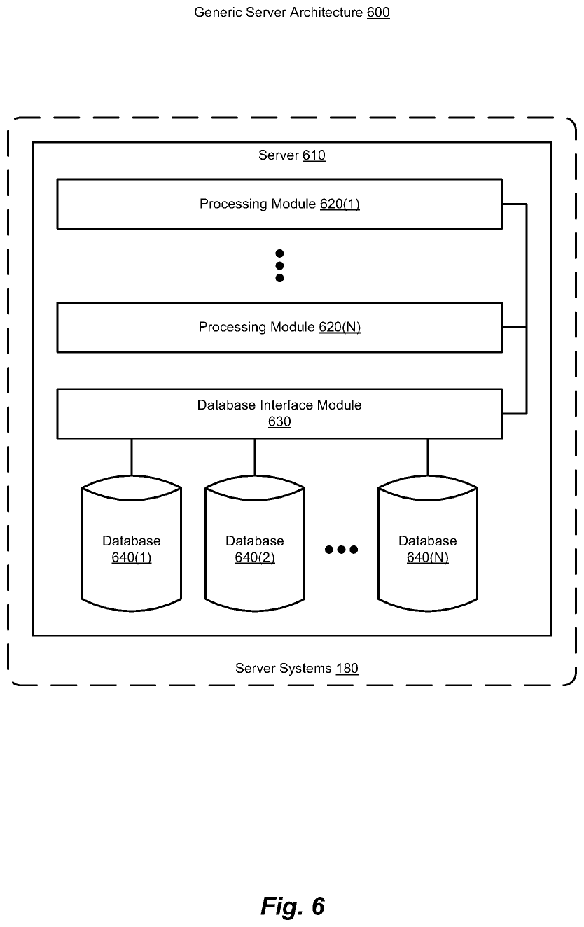

FIG. 6 is a block diagram illustrating an example of a generic server architecture, according to methods and systems such as those disclosed herein. FIG. 6 thus depicts a generic server architecture 600 that can be used to implement one or more of the server systems of server systems 180. A server of server systems 180 (depicted in FIG. 6 as a server 610) will thus include, typically, a number of components that support the maintenance and retrieval of digital information. For example, such components can include one or more processing modules (depicted in FIG. 6 as processing modules 620(1)-(N), a database interface module (depicted in FIG. 6 as a database interface module 630), and one or more databases (depicted in FIG. 6 as databases 640(1)-(N)). Generally, databases 640(1)-(N) store digital information pertinent to the processing performed by processing modules 620(1)-(N). Database interface module 630 provides one or more of processing modules 620(1)-(N) with access to databases 640(1)-(N). Additionally, database interface module 630 can provide other servers of the given server systems, as well as other components of the distributed manufacturing system, with access to databases 640(1)-(N). As noted, an example of such access is depicted in FIG. 1 by the various communications paths illustrated therein.

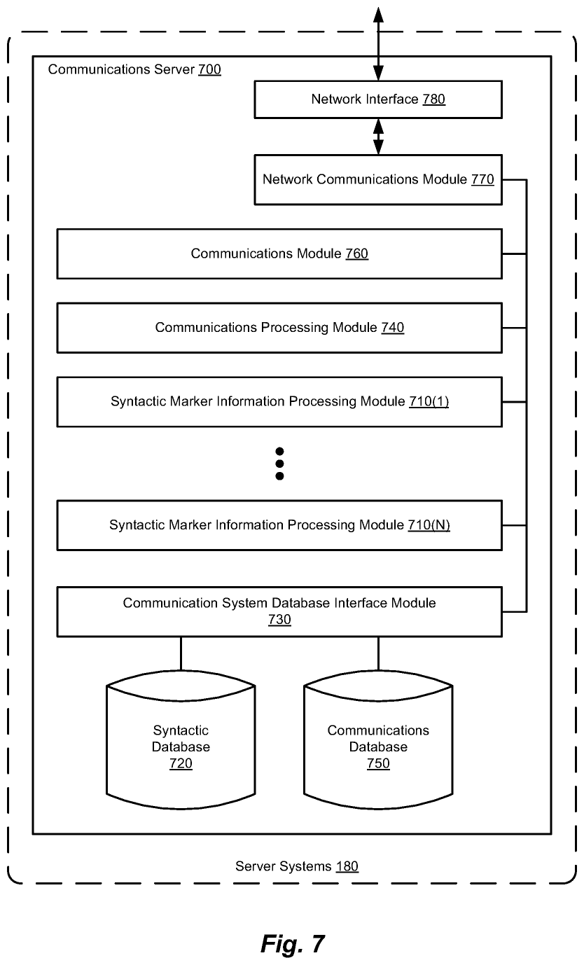

FIG. 7 is a block diagram illustrating an example of a communication server, according to methods and systems such as those disclosed herein. In certain embodiments, server systems 180 will include for such purposes one or more communications servers, such as a communications server 700. Communications server 700 includes a number of components that support functionalities related to program management and the management of communications regarding same (e.g., through the use of syntactic markers).

In one embodiment, communication server 700 includes one or more syntactic marker information processing modules (depicted in FIG. 7 as syntactic marker information processing modules 710(1)-(N)). Syntactic marker information processing modules 710, in certain embodiments, contain the requisite digital information from one or more other of the servers regarding the communications supported. In those or other embodiments, each of syntactic marker information processing modules 710 can be configured to process project communications and related information for one or more corresponding projects being managed. Syntactic marker information processing modules 710 can maintain such digital information in, for example, a syntactic database (depicted in FIG. 7 as a syntactic database 720) by communicating therewith via a communication system database interface module 730. In turn (or in parallel), one or more determinations can be made as to the project management information, for example, and requisite processing (e.g., identification of desired communications).

In support of such operations, production database interface module 730 can provide other servers of server systems 180, as well as other components of the program management and communication system, with access to syntactic database 720.

Operations such as those described generally above can be carried out by a communications processing module of communications server 700 (such as is depicted in FIG. 7 as a communications processing module 740). In performing such operations and making such determinations, communications processing module 740 can interface, via communication system database interface module 730, with a communications database (depicted in FIG. 7 as a communications database 750), and in so doing maintain information regarding the topology of the communications network supporting the program management functionalities described herein. Once the requisite information is available and the appropriate recipients identified and selected, such program management information can be communicated to the recipients under the control of a communications module (depicted in FIG. 7 as a communications module 760). Communications module 760 can, for example, retrieve the requisite information from syntactic database 720 and the recipients selected from communications database 750, via communication system database interface module 730. Communications module 760 then controls the communication of this information to the selected recipient(s) via a network communications module (depicted in FIG. 7 as a network communications module 770) and a network interface (depicted in FIG. 7 as a network interface 780). In certain embodiments, each of syntactic marker information processing modules 710 can be configured to process program management information for a given project, task, subtask, or other delineation, for example. As noted earlier, syntactic database 720 can, optionally, maintain digital information with regard to completed projects, and so (digitally) maintain the information needed to analyze a given project, upon that project's completion, or on an ongoing basis (even in a substantially real-time manner).

### Example Program Management Architectures

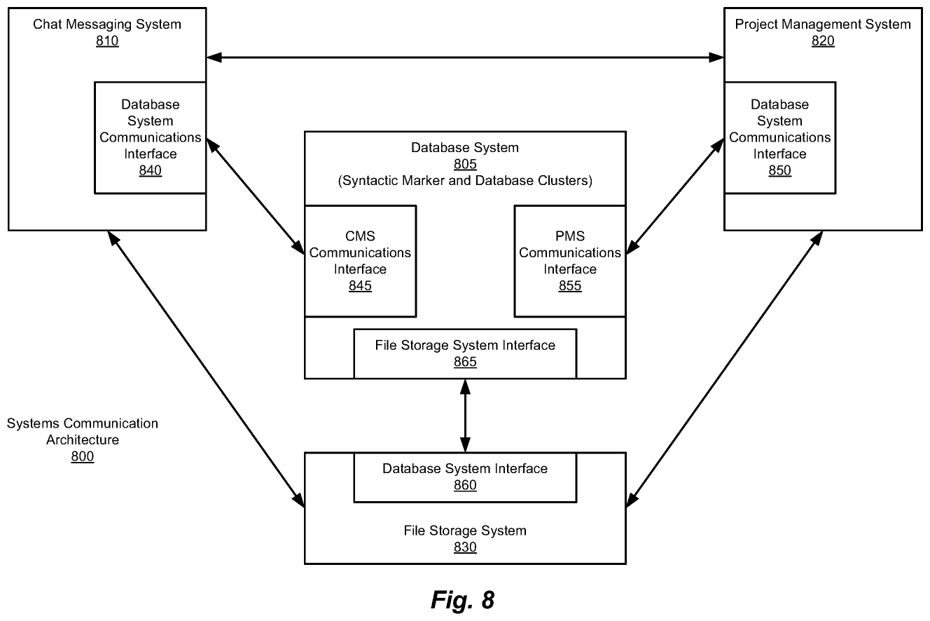

FIG. 8 is a block diagram illustrating an example of a inter-system communications architecture, according to methods and systems such as those disclosed herein. FIG. 8 thus depicts a systems communication architecture 800. In the communications architecture depicted in FIG. 8, the systems in systems communication architecture 800 are able to communicate with a database system 805 by virtue of including a chat messaging system 810, a project management system 820, and a file storage system 830. Each of chat messaging system 810, project management system 820, and file storage system 830 are comprise various components that result in these systems being configured to support program management functionalities such as those described herein. To that end, chat messaging system 810 includes a database systems communications interface 840, which supports communications with database system 805 by way of CMS communications interface 845 of database system 805. Further, project management system 820 includes a database systems communications interface 850, which supports communications with database system 805 by way of PMS communications interface 855 of database system 805. Further still, file storage system 830 includes a database systems communications interface 860, which supports communications with database system 805 by way of file storage system communications interface 865 of database system 805.

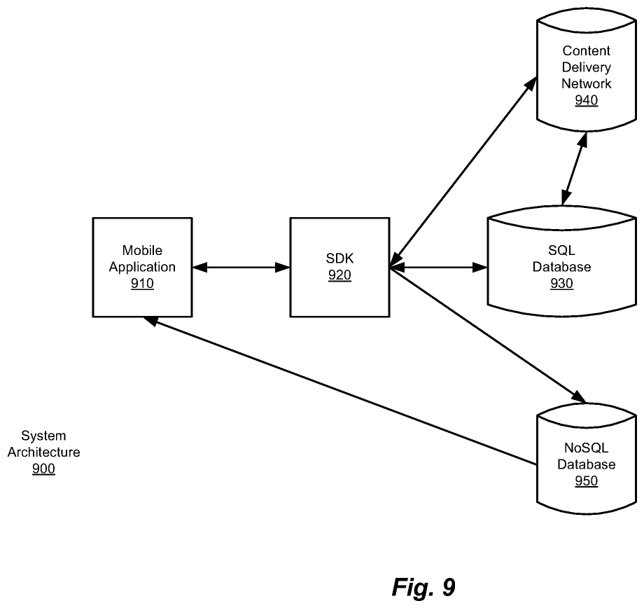

FIG. 9 is a block diagram illustrating an example of a system architecture, according to methods and systems such as those disclosed herein. FIG. 9 thus depicts a system architecture 900. System architecture is depicted as supporting a mobile application 910 (as might be installed on a mobile device such as those systems described earlier), which is in communication with components provided by a software development kit (SDK) 920. SDK 920 is, in certain embodiments, a collection of software development tools in an installable package. An SDK such as SDK 920 facilitates the creation of applications by, for example, providing a compiler, debugger, and a software framework, to create applications with advanced functionalities such as those described herein. SDK 920, in turn, communicates with a one or more SQL databases (e.g., an SQL database 930), which communicates with a content delivery network 940. SDK also facilitates communication of information back to mobile application 910. SDK 920 also facilitates communication of information to a NoSQL database 950, which is capable to providing information to mobile application 910 directly. The operations involved in certain such embodiments are discussed in connection with various of the figures, as described in more detail subsequently herein.

### Example Task Clusters Using Syntactic Markers

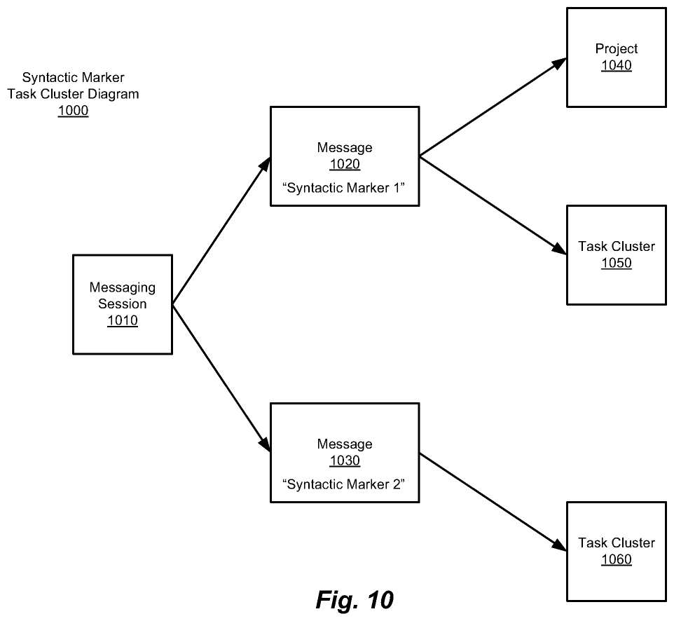

FIG. 10 is a block diagram illustrating an example of a syntactic marker task cluster diagram, according to methods and systems such as those disclosed herein. That being the case, a syntactic marker task cluster diagram 1000 is depicted. The example depicted as syntactic marker task cluster diagram 1000 presents an example of a messaging session (e.g., depicted in FIG. 10 as a messaging session 1010), which, in this depiction, includes examples of messages that are sent in messaging session 1010 (e.g., depicted in FIG. 10 as messages 1020 and 1030). Message 1020 includes a syntactic marker (e.g., “Syntactic Marker 1”) that allows the project management messaging system to identify projects and/or tasks affected by message 1020 (or to which message 1020 is considered relevant). In the example presented in syntactic marker task cluster diagram 1000, Syntactic Marker 1 is relevant to a project 1040 and a cluster of tasks (e.g., depicted in FIG. 10 as task cluster 1050). In this portion of the example, the contents of message 1020 are considered relevant and/or effect project 1040 by way of certain of its tasks, the tasks of task cluster 1050. Similarly, message 1030 also includes a syntactic marker (e.g., “Syntactic Marker 2”) that allows the project management messaging system to identify projects and/or tasks affected by message 1030 (or to which message 1030 is considered relevant), in this case, the tasks that result in task cluster 1060.

In certain embodiments, then, syntactic marker task cluster diagram 1000 illustrates an abstraction in which information from a messaging conversation can be stored in a specific database cluster utilizing Syntactic Markers as a way to identify specific messages that are related to specific tasks. One messaging conversation can have many different syntactic markers, with messages being stored into many different task database clusters. In syntactic marker task cluster diagram 1000, the message including the “Syntactic Marker 1” (e.g., which might be implemented using a unique alphanumeric identifier), message 1020, is related to task cluster 1050, which is linked to project 1040 (certain of the tasks for which are organized into task cluster 1050). Another message, message 1030, includes “Syntactic Marker 2”, which allows tasks to be organized into task cluster 1060.

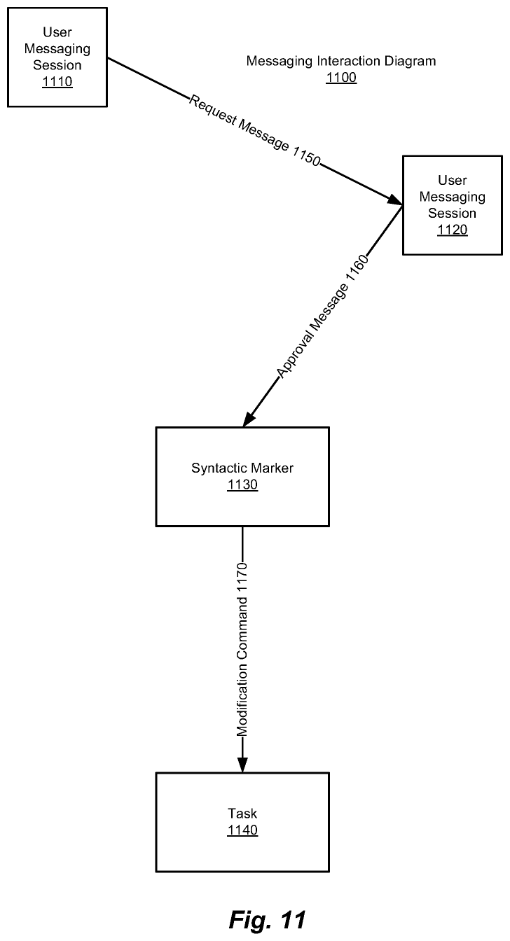

FIG. 11 is a block diagram illustrating an example of messaging interaction diagram, according to methods and systems such as those disclosed herein. That being the case, a messaging interaction diagram 1100 is depicted. As is illustrated in messaging interaction diagram 1100, a user messaging session 1110 of a given user is used to communicate with another user (a user receiving a messaging communication being a messaging communication recipient, or more simply, recipient), who is active in a user messaging session 1120. In these communication, a syntactic marker 1130 is used to identify, for example, a given task (e.g., depicted in FIG. 11 as a task 1140).

In the manner noted earlier, it will be appreciated that messaging interaction diagram 1100 is an abstract diagram of the manner in which two users, through the interaction of a messaging session, can trigger modifications of a task utilizing Syntactic Markers. These users, referred to, respectively, as user 1 and user 2, can both utilize syntactic marker 1130 as a mechanism by which to interact with task 1140, not only as a method to store messages but to trigger certain specific functions and/or operations. For instance, user 1 can ask user 2 for approval of a certain activity by communicating this request (including the appropriate syntactic marker) using the messaging system (e.g., depicted in FIG. 11 as a request message 1150). When user 2 approves that activity (also using that tactic marker) by communicating such approval (e.g., depicted in FIG. 11 as approval message 1160), the information within the task database cluster can be modified accordingly, depending on nature of the request (e.g., depicted FIG. 11 as a modification command 1170). Modification command 1170 thus results in the modification of information regarding task 1140 in the appropriate database(s), to reflect the interactions between user 1 and user 2.

### Example Program Management Architectures

FIG. 12 is a block diagram illustrating an example of a syntactic marker database system schema, according to methods and systems such as those disclosed herein. That being the case, a syntactic marker database system schema 1200 is depicted. Syntactic marker database system schema 1200 can, in various embodiments, include a number of interrelated tables, which support messaging functionality, project management functionality (e.g., by the tracking of programs/projects/tasks/subtasks/etc.), and other functionality, facilitated by support for the syntactic markers and task clustering described herein.

Syntactic marker database system schema 1200 includes, as noted, represents a number of interrelated tables in a database schema. This embodiment is an example of a structure that can be utilized to implement syntactic marking and task clustering functionality according to the present disclosure. To support messaging functionality, such tables can include a user table 1210, a session member table 1215, a conversation table 1220, and a message table 1225. In the embodiment depicted as syntactic marker database system schema 1200, conversation table 1220 maintains information regarding the various messaging sessions (“conversations”) being conducted between users. Information regarding such messages within the messaging system is maintained in message table 1225, which is referred to by conversation table 1220 (illustrated by reference 1226). Conversation table 1220 also refers to session member table 1215, in order to identify the users who are involved in (members of) a given messaging session (“conversation”) (illustrated by reference 1227). Session member table 1215, in turns, refers to user table 1210 (illustrated by reference 1228), which maintains information regarding each of the users of the messaging system. To this end, it will be appreciated in light of the present disclosure that such information can include identifying information, contact information, permission information, and other information, as may be relevant to a given individual's access and use of the messaging system. For example, permission information can include information regarding a user's access level (e.g., that the user in question is granted the ability to tag messages, only to send and receive messages, or only to read the messages of a given messaging session, for example).

To support project management functionality, such tables can include a project table 1230, a task table 1235, and a project task member table 1240. In the embodiment such as is depicted as syntactic marker database system schema 1200, the projects and tasks contemplated are those related to construction activities, although it is to be appreciated that such functionality finds up the ability in a wide range of applications. In this embodiment, information regarding a given program's projects is maintained in project table 1230, which refers to task table 1235 (illustrated by reference 1241), which maintains information regarding the tasks of each project. As will be appreciated in light of the present disclosure, additional such tables can be envisioned for implementation and referencing of subtasks and other such subdivisions of work, as may be desirable in the given implementation. Information regarding the individuals responsible for such projects and tasks is maintained in project task member table 1240, to which project table 1230 refers (illustrated by reference 1242). As can be also seen, task table 1235 also refers to project task member table 1240 (illustrated by reference 1243), also in order to maintain information regarding the individuals responsible for a project's various tasks. In turn, project task member table refers to user table 1210, in order to make available user information for members of a project or task (illustrated by reference 1244).

Program management functionality is further supported by a task bid table 1250, a task payment table 1255, and a data table 1260. Thus, in addition to task table 1235 and project task member table 1240 (e.g., in order to maintain information regarding the responsibility for projects and tasks, and the individuals responsible for them), project table 1230 refers to data table 1260 (as is illustrated by reference 1261), as does task table 1235 (as is illustrated by reference 1262). Data associated with such projects and their tasks is therefore maintained in (or is, at least, referenced by) entries in data table 1260. Similarly, task table 1235 refers to task table 1250 (in order to maintain bid information for a given task, and illustrated by reference 1263) and task payment table 1255 (in order to maintain information regarding payments made for a project's various tasks, and illustrated by reference 1264). Task bid table 1250, task payment table 1255, and data table 1260 are also referenced by message table 1225 (as is illustrated by references 1265, 1266, and 1267, respectively). As will be appreciated in light of the present disclosure, such references reflect the ability of the messages maintained in message table 1225 to include or reference information regarding bids, payments, and the various types of data referred to by the entries of data table 1260.

In fact, it should be noted that a number of relationships between the tables facilitating messaging functionality and those facilitating project management functionality exist. As before, information regarding the individuals identified in project task member table 1240 is maintained in user table 1210. Further, message table 1225 refers to task bid table 1250, task payment table 1255, and data table 1260. Such references demonstrate the messaging system's use and communicating information regarding projects and tasks, and also in the maintenance of information regarding such projects and tasks.

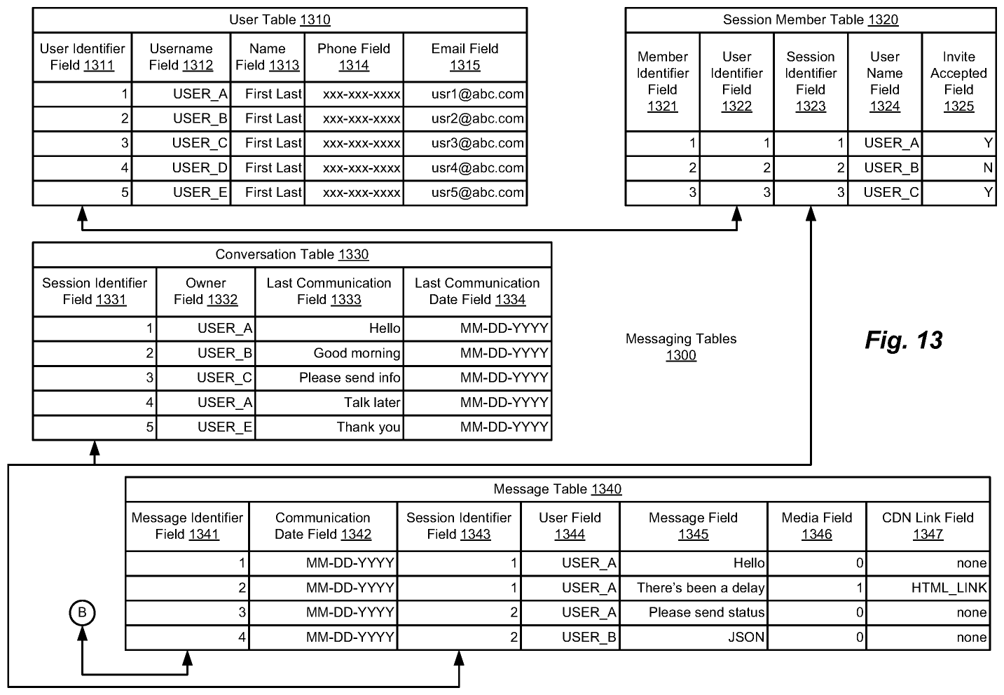

Further in support of such messaging and project management functionality, an embodiment of syntactic marker database system schema 1200 such as that depicted in FIG. 12 can include a project task log table 1270 and a syntactic marker table 1280, which maintain information in support of the functionality of the syntactic markers (e.g., and so facilitate program management functionality using messaging functionality to, for example, organize tasks into task clusters). For example, project task log table 1270 and syntactic marker table 1280 are referred to by message table 1225, project table 1230 and task table 1235 (as is illustrated by references 1281, 1282, 1283, 1284, 1285, and 1286, respectively). The messages that are the subject of message table 1225 can include syntactic markers, the information for which is maintained in syntactic marker table 1280, and refers to project task log table 1270, allowing the messages that message table 1225 maintains to affect the status of tasks, as reflected in the information maintained in project task log table 1270. Similarly, project table 1230 and task table 1235 both referred to project task log table 1270 and syntactic marker table 1280, in order to associate the various projects and tasks in a manner that reflects the information maintained in project task log table 1270 and syntactic marker table 1280 (as created and updated by the messages of message table 1225). The various pieces of information maintained by the tables of syntactic marker database system schema 1200 and their interrelationships are described in greater detail in connection with FIGS. 13-16, subsequently.

FIG. 13 is a block diagram illustrating an example of messaging tables of a syntactic marker database system such as that described in connection with FIG. 12, according to methods and systems such as those disclosed herein. That being the case, messaging tables 1300 are depicted. Messaging tables 1300 includes a user table 1310, which, in turn, includes a user identifier field 1311, a username field 1312, a name field 1313, a phone field 1314, and an email field 1315. Messaging tables 1300 also include a session member table 1320, which, in turn, includes a member identifier field 1321, a user identifier field 1322, a session identifier field 1323, a username field 1324, and an invite accepted field 1325. Also included in messaging tables 1300 is a conversation table 1330, which, in turn, includes a session identifier field 1331, an owner field 1332, a last communication field 1333, and a last communication date field 1334. Messaging tables 1300 also include a message table 1340, which, in turn, includes a message identifier field 1341, a communication date old 1342, a session identifier field 1343, a user field 1344, a message field 1345, a media field 1346, and a content delivery network (CDN) link field 1347.

As is depicted in FIG. 13, user table 1310 maintains information regarding the users of a messaging system according to embodiments such as those described herein (e.g., such as that described in connection with FIG. 3), and a database therefor (e.g., such as that described in connection with FIG. 12). To that end, user table 1310 stores information regarding each user, and so provides username field 1312 (which is used to maintain an user's username in the messaging system, name field 1313 (which is used to maintain an user's actual name, phone field 1314 (which is used to maintain information regarding an user's telephone number), and email field 1315 (which is used to maintain an user's email address). As will be appreciated in light of the present disclosure, the user just referred to can be a person in their individual capacity, as a representative of an organization or vendor, or the like, and generally refers to an account used to access the messaging system. That being the case, each such account is identified by user identifier information (also referred to as a “user ID”), and which is maintained in user identifier field 1311. To this end, a user identifier maintained in user identifier field 1311 is referred to by the corresponding field in session member table 1320 (user identifier field 1322), as is indicated by the relationship between these fields depicted in FIG. 13. In so doing, information regarding users identified as members of the given messaging session by user identifier field 1322 of session member table 1320 can, after determining a given message group's membership, be determined by using the user's user identifier to refer to information in user table 1310. This represents reference 1228 of FIG. 12.

As will also be appreciated light of the present disclosure, any number of additional fields can be, and often will be, included in user table 1310. Information maintained in such additional fields can include any information regarding a user, as may be relevant to the operation of the messaging system or useful to its users (e.g., including address information, emergency contact information, user preferences, and any other relevant information). It will be further appreciated that fields for the maintenance of such information are not shown in FIG. 13 for the sake of simplicity. Examples in user table 1310 include the information maintained in username field 1312, name field 1313, phone field 1314, and email field 1315. In session member table 1320, in addition to identifying each member of a given session (maintained in member identifier field 1321, session member table 1320 includes a username field 1324 (reflecting the information maintained in username field 1312), and information maintained in invite accepted field 1325 (reflecting, in certain embodiments, whether the user in question has accepted an invitation to communicate via the messaging system). In conversation table 1330, such information can include owner information (maintained an owner field 1332, indicating the user tasked with moderating the conversation), the last communication sent in the conversation (maintained in last communication field 1333), and the date of the last communication (maintained in last communication date field 1334). In comparable fashion, information in message table 1340 can include the date of the communication in question (maintained in communication date field 1342), the user communicating that message (maintained in user field 1344), the message itself (maintained in message field 1345), whether or not any media is associated with a message (maintained in media field 1346), and if such media is associated with a message, a link to that data (maintained in CDN link field 1347).

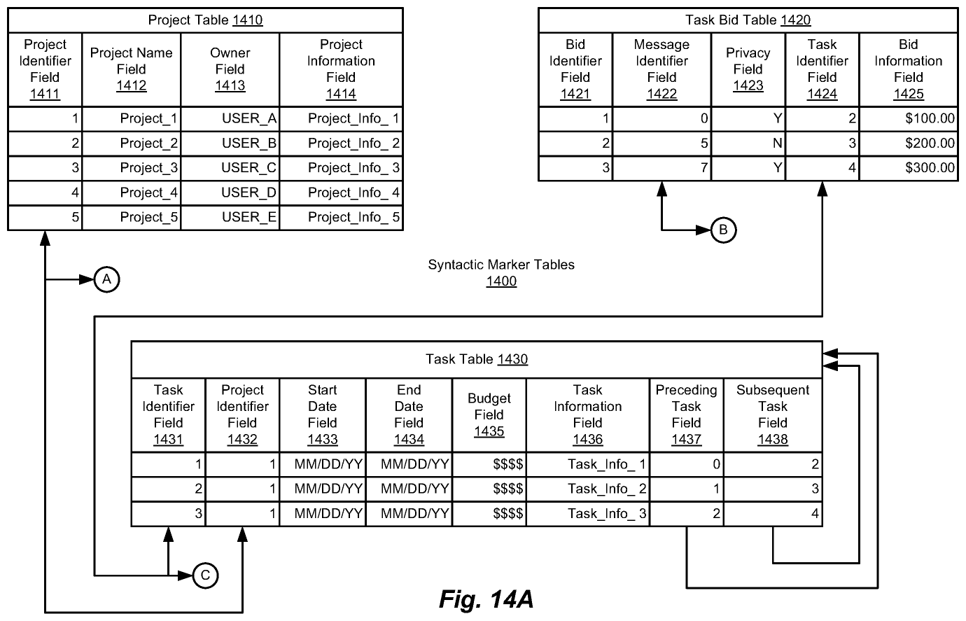

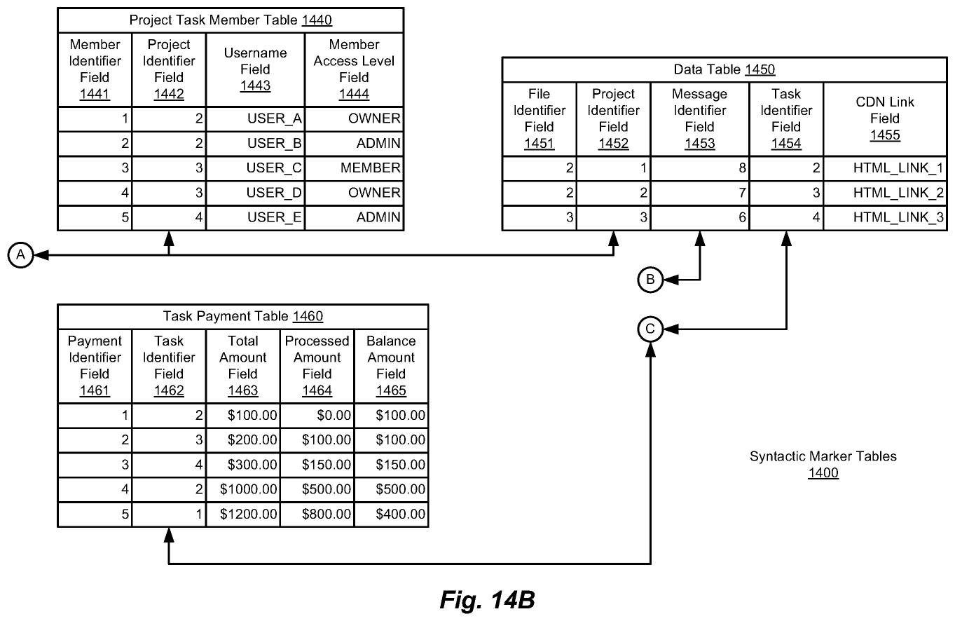

Similarly, a session identifier is maintained in in each of session identifier field 1323, session identifier field 1331, and/or session identifier field 1343, in order to facilitate the identification of conversations and the users involved therein as being part of a given messaging session. As noted earlier, a messaging session can be identified using such a session identifier. For a given session identifier, these fields allow the identification of messages on a per-conversation basis, and so provide for the identification of session members (e.g., as by reference 1227, with conversation table 1330 referencing session member table 1320, and so user table 1310 by reference numeral 1228), as well as the messages maintained in message table 1340, referenced by entries in conversation table 1330 (e.g., as by reference numeral 1226). In turn, message table 1225 may refer to data maintained in other database tables, which is indicated by the reference “B” (e.g., reference 1267 of FIG. 12), which is discussed in greater detail in connection with FIG. 14B.

FIGS. 14A and 14B are block diagrams illustrating an example of syntactic marker tables of a syntactic marker database system such as that described in connection with FIG. 12, according to methods and systems such as those disclosed herein. That being the case, syntactic marker tables 1404 are depicted. Syntactic marker tables 1400 include a project table 1410, a task bid table 1420, a task table 1430, a project task member table 1440, a data table 1450, and a task payment table 1460. As will be appreciated in light of the present disclosure, certain of these tables (e.g. task payment table 1460) are appropriate to the bidding, performance, completion, and billing of, for example, construction projects. In the example depicted in FIGS. 14A and 14B, syntactic marker tables 1400 inclusion of such tables lends methods and systems such as those described herein to such applications.

In view of the foregoing, FIG. 14A depicts project table 1410 as including a project identifier field 1411, a project name field 1412, an owner field 1413, and project information field 1414. Similarly, task bid table 1420 includes a number of fields, including a bid identifier field 1421, a message identifier field 1422, a privacy field 1423, a task identifier field 1424, and information field 1425. In turn, task table 1430 includes a number of fields, including a task identifier field 1431, a project identifier field 1432, a start date field 1433, and end date field 1434, a budget field 1435, a task information field 1436, a proceeding task field 1437, and a subsequent task field 1438.

Moving on to the tables depicted in FIG. 14B, syntactic marker tables 1400 include, as noted, project task member table 1440. Project task member table 1440 includes a member identifier field 1441, a project identifier field 1442, a username field 1443, and a member access level field 1444. Also included in syntactic marker tables 1400 is data table 1450, as noted. Data table 1450 includes a file identifier field 1451, a project identifier field 1452, a message identifier field 1453, a task identifier field 1454, and a content delivery network (CDN) field 1455. It will be appreciated that the data in question can be included in the entry of data table 1450 and/or (as depicted in CDN field 1455) identified by a link to that data, for example. In the former case, the data is included in the entry in question, and in the latter, the location of the data can be identified using a link stored in CDN field 1455. Moreover, such data can be accessed by way of a syntactic marker, which can be used to identify the desired entry of data table 1450 through one or more of the corresponding project identifier, message identifier, and/or task identifier, identified thereby. Further, such data can be stored in a file (or other data storage construct) identified by information in file identifier field 1451. To this end, such a file can be stored using the given syntactic marker(s), project identifier(s), and/or task identifier(s), for example. In one embodiment, a syntactic marker, project identifier, and/or task identifier can be combined to form the address of a storage location (e.g., such information can be used to form a directory path in the given filesystem, such as DRIVE:\syntactic_marker\project_identifier\task_identifier\data_file). As noted, task payment table 1460 is included as one of syntactic marker tables 1400. Task payment table 1460 includes a payment identifier field 1461, a task identifier field 1462, a total amount field 1463, a processed amount field 1464, and a balance amount field 1465.

Starting with project table 1410, it can be seen that information regarding each of the projects' information maintained in project table 1410 includes one or more project identifiers (also referred to herein as a product ID; maintained in project identifier field 1411) that serve as references to the tasks making up those projects, information regarding which is maintained in task table 1430 (in project identifier field 1432), and which is represented by reference numeral 1241 of FIG. 12. Such reference is also indicated by reference “A” (e.g., references 1242 and 1261 of FIG. 12), which reference project task member table 1440 (such project identifiers being maintained in project identifier field 1442) and data table 1450 (such project identifiers being maintained in project identifier field 1452). Such references allow one or more individuals to be associated with a given project via a project task member table 1440 (in which, for a given project, a member identifier stored in member identifier field 1441 and a project identifier stored in project identifier field 1442 associates the individual with the project in question as a member of that project), and allow pieces of data maintained in/referred to by the entries of data table 1450 to be associated with a project identified by a project identifier maintained in project table 1410, respectively.

Other referencing information includes one or more task identifiers maintained in task table 1430 (in task identifier field 1431), which references information in task bid table 1420 (using task identifiers maintained in task identifier field 1424). Such reference is also indicated by reference “C” (e.g., references 1262, 1263, and 1264 of FIG. 12), which reference project task member table 1440 (such project identifiers being maintained in project identifier field 1442) and data table 1450 (such project identifiers being maintained in project identifier field 1452).

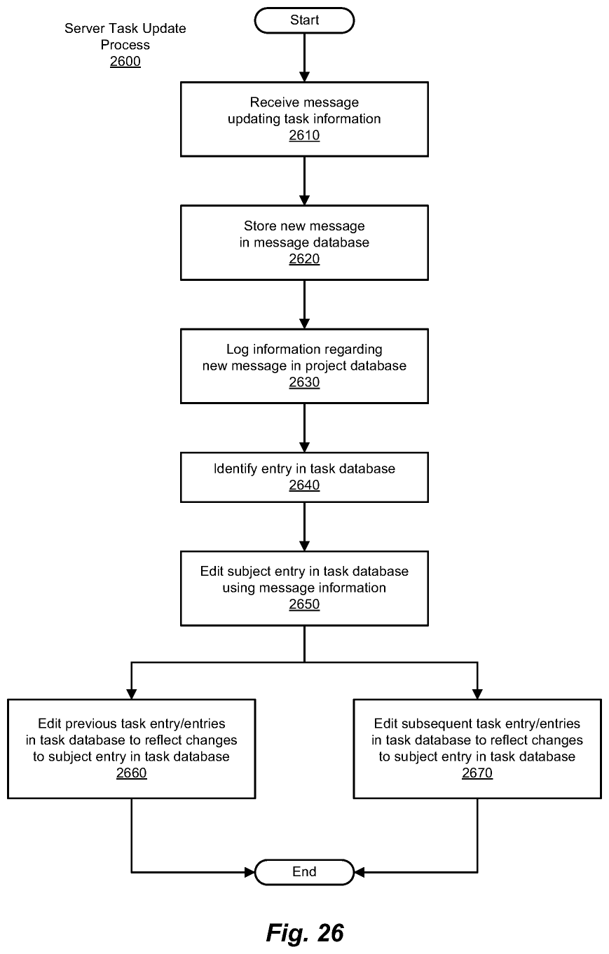

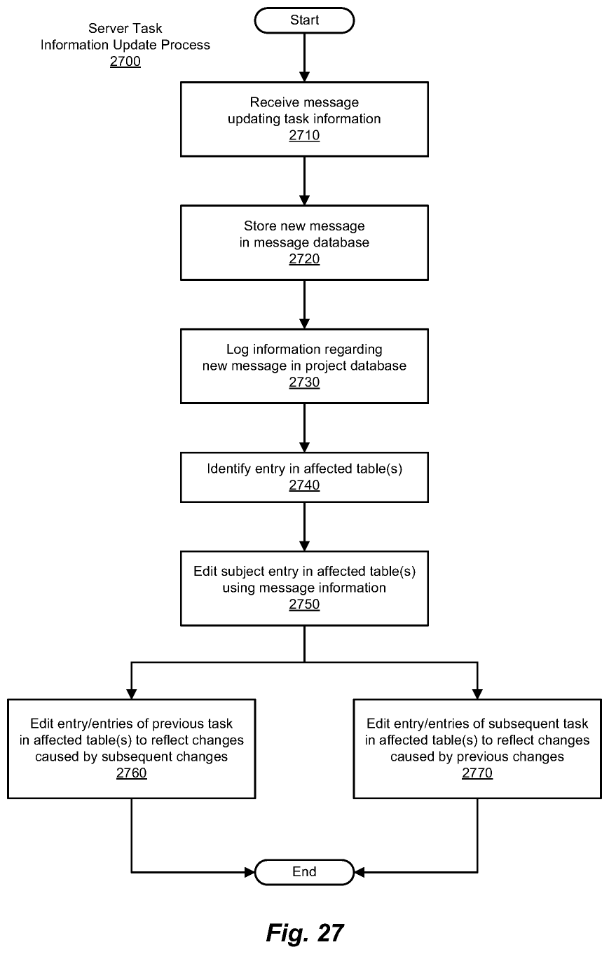

In the architecture depicted in FIG. 14A, task table 1430 also includes two fields that are used to propagate effects of changes to the database tables of syntactic marker tables 1400. In the example depicted, task identifiers stored in preceding task field 1437 identify one or more tasks (by task identifier) referred to tasks, the information of which depends on the task in question. Similarly, task identifiers stored in subsequent task field 1438 identify one or more tasks (by task identifier) to which the task in question refers. The use of such references are discussed in connection with FIGS. 26 and 27.

Still other referencing information includes one or more message identifiers maintained in message identifier field 1422 of task bid table 1420 (as noted earlier in connection with FIG. 13) and in message identifier field 1453 of data table 1450. Maintaining message identifier information in message identifier fields 1422 and 1453 identifies the data in/referred to by a given message, which is indicated by the reference “B” (e.g., references 1265 and 1267 of FIG. 12). Such references allow a given bid and a given piece of data to be associated with one or more messages, which, in turn, make up the messaging sessions identified in conversation table 1330.

Here again, any number of additional fields can be, and often will be, included in the tables of syntactic marker tables 1400. In the manner noted, such additional information can include any information regarding the projects, tasks, and bids listed in project table 1410, task table 1430, and task bid table 1420. It will be further appreciated that fields for the maintenance of such information are not shown in FIGS. 14A and 14B for the sake of simplicity. That said, a variety of example fields are depicted, including project name field 1412, owner field 1413, project information field 1414, privacy field 1423, bid information field 1425, start date field 1433, and date field 1434, budget field 1435, and task information field 1436.

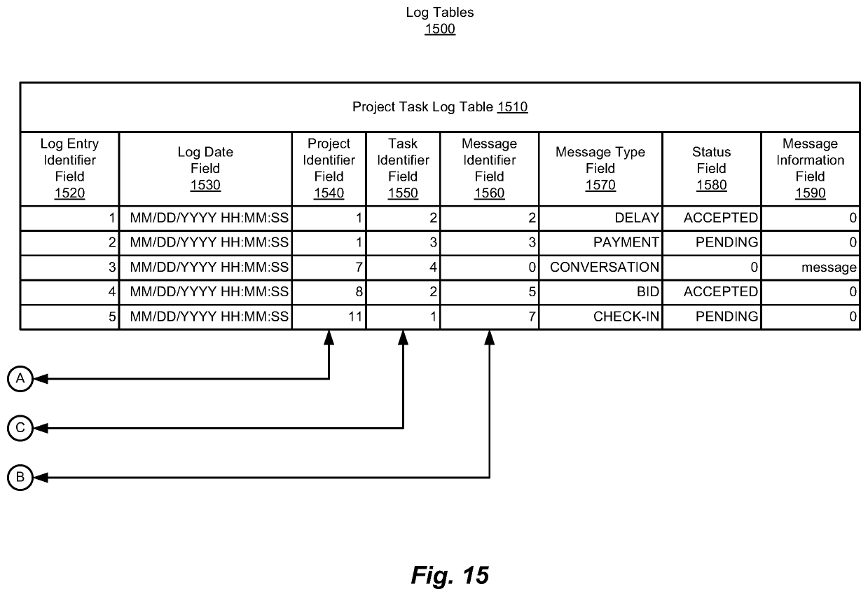

FIG. 15 is a block diagram illustrating an example of log tables of a syntactic marker database system schema such as that depicted in FIG. 12, according to methods and systems such as those disclosed herein. That being the case, log tables 1500 are depicted. Log tables 1500 include one or more project task log tables (e.g., an example of which is depicted in FIG. 15 as a project task log table 1510). Log table 1510, in turn, includes a log identifier field 1520, a log date field 1530, a project identifier field 1540, a task identifier field 1550, a message identifier field 1560, a message type field 1570, a status field 1580, and a message information field 1590.

In view of this, project task log table 1510 can be seen to maintain log information for each task of the projects identified, in each entry of project task log table 1510. Such information can include a log entry identifier (maintained in log entry identifier field 1520, the time and date of the event being logged (maintained in log date field 1530), the type of event(s) (maintained in message type field 1570), and the status of the given task (maintained in status field 1580. Also included in project task log table 1510 is an indication of information contained in the message (if any; such information (e.g., a message body) being in, for example, a file or other such construct, in JavaScript Object Notation (JSON), extensible markup language (XML), or the like), which is maintained in message information field 1590. As will be appreciated light of the present disclosure, an event logged in project task log table 1510 can be the result of a message, or may represent a change in the state of the task, for example (which itself may be the result of a message). Project task log table 1510 also includes a project identifier (maintained in project identifier field 1540) that serves as a reference to the project with which the affected task is associated, a task identifier (maintained in task identifier field 1550) that serves as a reference to the task with regard to which the event was logged, and a message identifier (maintained in message identifier field 1560) that identifies the message (resulting in the logged event) that is associated with the affected task and/or project. In this regard, it is to be appreciated that a message can, in fact (and although not depicted as such), be of multiple message types. This can be achieved in a number of ways, including the use of multiple message type columns, codes for combinations of messages types, multiple entries in project task log table 1510 for a multiple-message-type message, and other such alternatives (or combinations thereof).

It is to be further appreciated that, by including syntactic markers of an appropriate type, messages sent via a messaging system such as those described herein are able to affect the status of the projects/tasks/subtasks/etc. to which those messages relate. The status of such events that may result from such messages can then be maintained in status field 1580. Thus, in the examples depicted in project task log table 1510, the actions represented by the log entries identified by log identifiers 1 and 4 (DELAY and BID, respectively) have been accepted, while the actions represented by the log entries identified by log identifiers 2 and 5 (PAYMENT and CHECK-IN, respectively) are pending, awaiting acceptance (or denial). The log entry identified by log identifier 3 (CONVERSATION) has a status of “0”, indicating that the message logged as that log entry is simply a message, but therefore does have message information in message information field 1590. By contrast, message information in message information field 1590 for each of the remaining messages (logged with identifiers 1, 2, 4, and 5) is “0” (or null), indicating that no message information is associated therewith. As will be appreciated in light of the present disclosure, a message can result in one or more actions, and also include message information, in which case, the entry in project task log table 1510 for such a message would include multiple message types (e.g., in message type field 1570), one or more statuses (e.g., in status field 1580), and message information field in message information field 1590.

As noted earlier, the project identifier stored in the given entry's project identifier field 1540 allows the messaging system to refer to project table 1230 (represented by reference numeral 1283 of FIG. 12) and task table 1235 (represented by reference numeral 1285 of FIG. 12). Such reference is also indicated by reference “A” (which, e.g., is reflected as references 1241, 1242, and 1261 of FIG. 12), which reference project table 1410, project task member table 1440, and data table 1450, in the manner noted. Such references allow entries in project task log table 1510 to identify projects listed in project table 1410 and associate the given project with the event logged in project task log table 1510. In comparable fashion, task identifier information stored in task identifier field 1550 of project task log table 1510 identifies one or more tasks affected by the event logged as an entry in project task log table 1510. Such a task identifier references information in task bid table 1420, task table 1430 (the task(s) in question), task payment table 1460, data table 1450, as well as other tables of syntactic marker tables 1400. Such reference is also indicated by reference “C” (e.g., by various of the references depicted in FIG. 12, including references 1263 and 1265, as well as combinations of references that proceed from one table to the next, and so allow reference to the requisite tables).

In order to associate a message and a message log entry with one another, a message identifier stored in message identifier field 1560 of project task log table 1510 facilitates identification of the message resulting in the event logged in project task log table 1510. Maintaining message identifier information in message identifier field 1560 identifies the given message, which is indicated by the reference “B” (e.g., reference 1281 of FIG. 12).

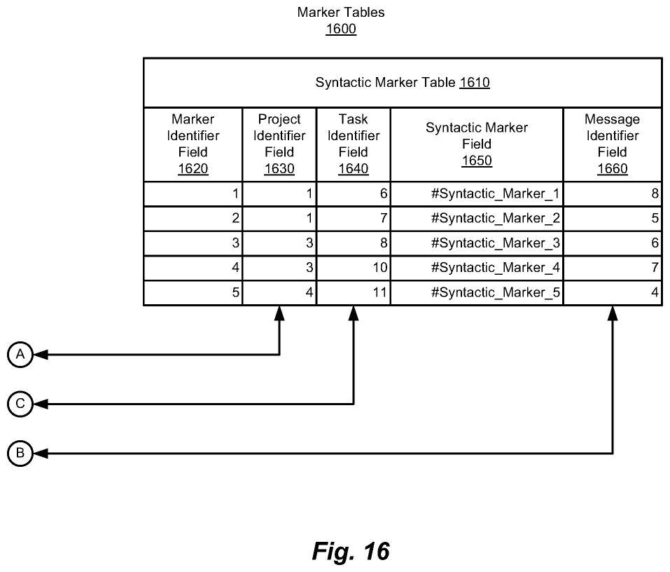

FIG. 16 is a block diagram illustrating an example of marker tables of a syntactic marker database system such as that described in connection with FIG. 12, according to methods and systems such as those disclosed herein. That being the case, marker tables 1600 are depicted. Marker tables 1600 can include one or more syntactic marker tables (e.g., an example of which is depicted in FIG. 15 as a syntactic marker table 1610). Syntactic marker table 1610, in turn, includes a marker identifier field 1620, a project identifier field 1630, a task identifier field 1640, a syntactic marker field 1650, and a message identifier field 1660.

Syntactic marker table 1610 organizes information regarding the syntactic markers created in the messaging system by assigning each such marker a marker identifier, which can then be stored in marker identifier field 1620, with the syntactic marker itself (e.g., information representing the syntactic marker) stored in a corresponding syntactic marker field 1650, associating the syntactic marker and its marker identifier by their storage in the given entry of syntactic marker table 1610. Also stored in this entry will be a project identifier (maintained in project identifier field 1630), a task identifier (maintained in task identifier field 1640), and a message identifier (maintained in message identifier field 1660). By maintaining such information with respect to a given project, task, and message (or multiple ones thereof), each entry of syntactic marker table 1610 is able to associate such projects, tasks, and messages with one another using such syntactic markers.

To this end, the project identifier stored in the given entry's project identifier field 1630 allows the messaging system to be referred to by project table 1230 (represented by reference numeral 1284 of FIG. 12) and task table 1235 (represented by reference numeral 1286 of FIG. 12). Such reference is also indicated by reference “A” (which, e.g., is reflected as references 1241, 1242, and 1261 of FIG. 12), which reference project table 1410, project task member table 1440, and data table 1450, in the manner noted. Such references allow entries in syntactic marker table 1610 to identify projects listed in project table 1410 and associate the given project with the syntactic marker maintained in syntactic marker table 1610. In comparable fashion, task identifier information stored in task identifier field 1640 of syntactic marker table 1610 identifies one or more tasks associated with the syntactic marker stored in syntactic marker field 1650. Such a task identifier references information in task bid table 1420, task table 1430 (the task(s) in question), task payment table 1460, data table 1450, as well as other tables of syntactic marker tables 1400. Such reference is also indicated by reference “C” (e.g., by various of the references depicted in FIG. 12, including references 1263 and 1265, as well as combinations of references that proceed from one table to the next, and so allow reference to the requisite tables). Similarly, a message identifier stored in message identifier field 1660 of syntactic marker table 1610 facilitates identification of the message(s) associated with the given syntactic marker. Maintaining message identifier information in message identifier field 1660 thus facilitates identification of the given message, which is indicated by the reference “B” (e.g., reference 1282 of FIG. 12).

### Example Program Management Processes

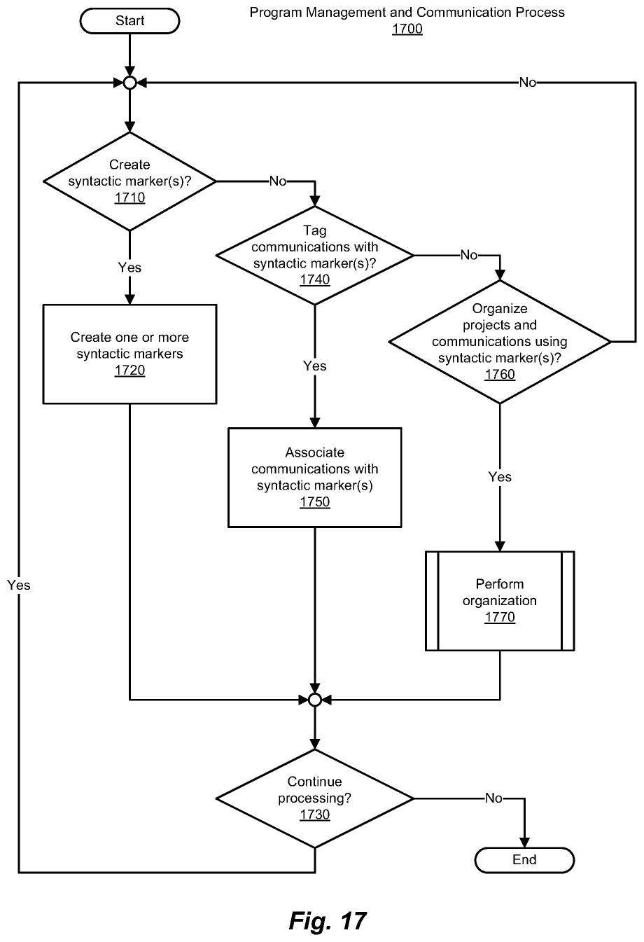

FIG. 17 is a flow diagram illustrating an example of a program management and communication process, according to one embodiment. FIG. 17 thus depicts a program management and communication process 1700. Program management and communication process 1700 begins with a determination as to whether one or more syntactic markers should be created (1710). If one or more syntactic markers are to be created, program management and communication process 1700 proceeds to the creation of the desired syntactic markers (1720). The creation of syntactic markers can be accomplished, for example, by entering alphanumeric information in a tag creation dialogue in a messaging user interface, as part of communicating with other users regarding projects and/or tasks, using a messaging system such as that described herein. A determination is then made as to whether processing of projects and messaging using syntactic markers is to continue (1730). If such processing is to continue, program management and communication process 1700 iterates to the aforementioned determination (1710), and program management and communication process 1700 proceeds. In the alternative, program management and communication process 1700 concludes.

Alternatively, if no (additional) syntactic markers are to be created (1710), a determination is made as to whether one or more communications (messages) are to be tagged with one or more syntactic markers (1740). If one or more syntactic markers were to be used to tag desired communications, those communications are associated with the syntactic markers in question (1750). The association of syntactic markers can be accomplished, for example, by entering alphanumeric information in a tagging dialogue in a messaging user interface, as part of communicating with other users regarding projects and/or tasks, using a messaging system such as that described herein. Program management and communication process 1700 then proceeds to a determination as to whether the processing of projects and messages should continue (1730). As before, if such processing is to continue, program management and communication process 1700 iterates to the determination regarding the creation of one or more syntactic markers (1710), and program management and communication process 1700 proceeds. In the alternative, program management and communication process 1700 concludes.

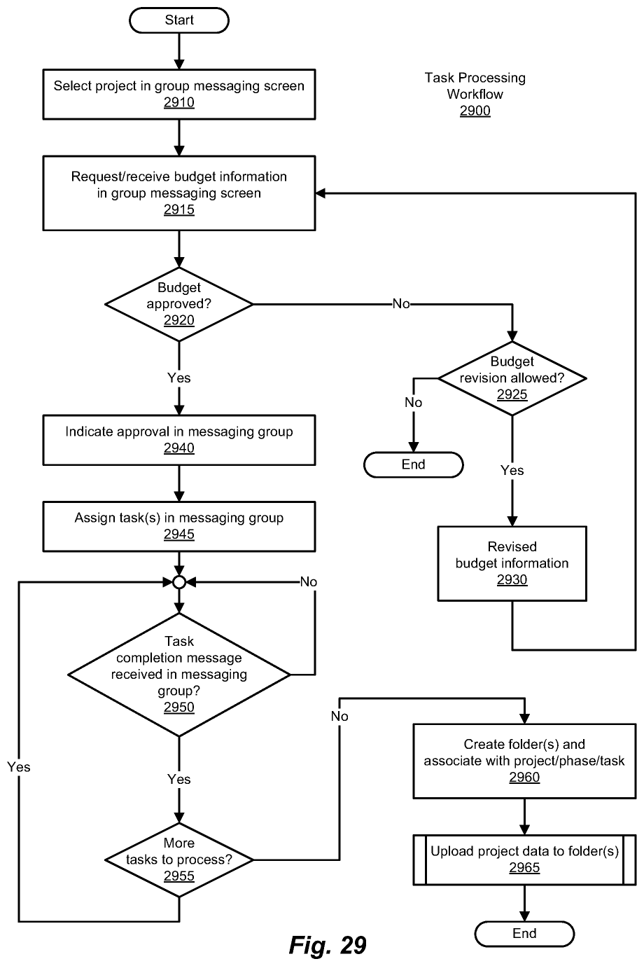

While the creation of syntactic markers and their use in tagging communications are described as separate processes with respect to program management and communication process 1700, such need not be the case. In fact, such operations can be combined in the messaging of information regarding projects and tasks, which can even be done as an “on-the-fly” operation. Such functionality is described in connection with the workflows that are the subject of FIGS. 29-35, subsequently. Further, any of the syntactic marker(s) used to tag the communication(s) in question maybe those created as part of the earlier-described operations of program management and communication process 1700, or may be just syntactic markers, created prior to their use.

As will be appreciated in light of the present disclosure, the association of the syntactic marker(s) can be performed before, during, or after such communications, and may include information associated with such communications. Once determinations as to syntactic marker creation (1710) and communication tagging using such syntactic markers (1740), a determination can then be made as to the organization of projects/tasks and communications regarding same (1760). Organization of such communications can then be accomplished using the syntactic marker(s) associated with such projects/tasks by way of the aforementioned messages (1770). Program management and communication process 1700 then concludes. A determination is then made as to whether processing of projects and messaging using syntactic markers is to continue (1730). If such processing is to continue, program management and communication process 1700 iterates to the aforementioned determination (1710), and program management and communication process 1700 proceeds. In the alternative, program management and communication process 1700 concludes.

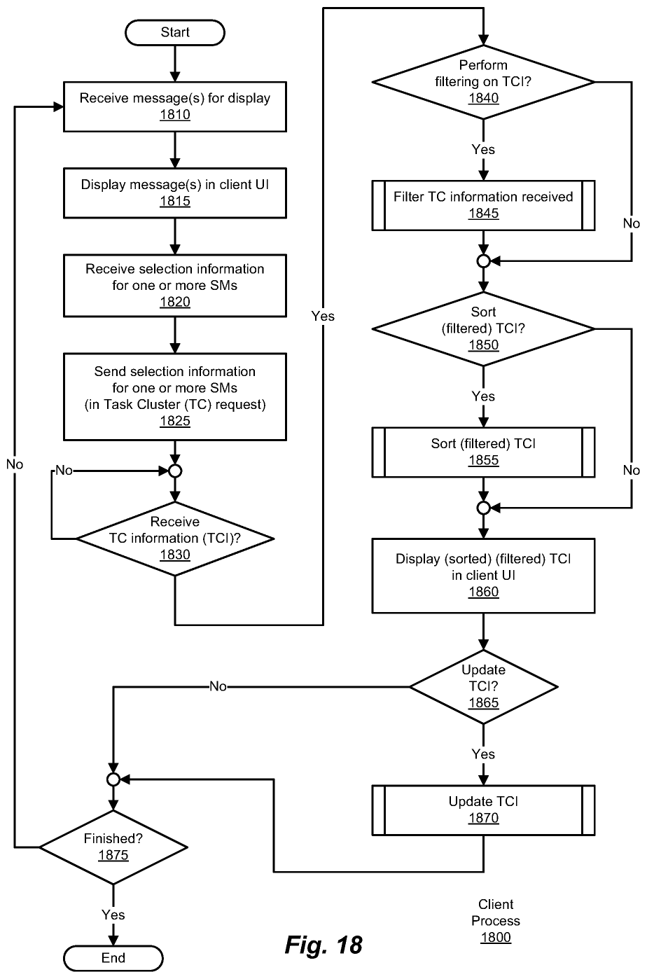

In the manner noted, it is to be appreciated in light of the present disclosure that, while the creation of syntactic markers and their use in tagging and organizing communications and projects tasks/subtasks/etc. are described as separate processes with respect to program management and communication process 1700, such need not be the case. In fact, such operations can be combined in the messaging of information regarding projects and tasks, which can even be done as an “on-the-fly” operation. Such functionality is described in connection with the workflows that are the subject of FIGS. 29-35, subsequently. Further, such organizational functions are described in connection with FIG. 18, subsequently. To this end, a fuller description of the operations associated with the functionality of program management and communication process 1700 is provided in connection with the following figures.

FIG. 18 is a flow diagram illustrating an example of a client process, according to methods and systems such as those disclosed herein. That being the case, a client process 1800 is depicted. Client process 1800 begins with the receipt of messages for display (1800). Messages thus received are displayed in a client user interface (UI) of a user's device (1815). At this juncture, in relevant part, one or more selections are received via the UI, selecting information for one or more syntactic markers (SMs) (1820). Information regarding the selection of one or more syntactic markers is then sent in a task cluster (TC) request (1825). The user's client device then awaits receipt of the task cluster information (TCI) (1830). Client process 1800 loops until such TCI is received.

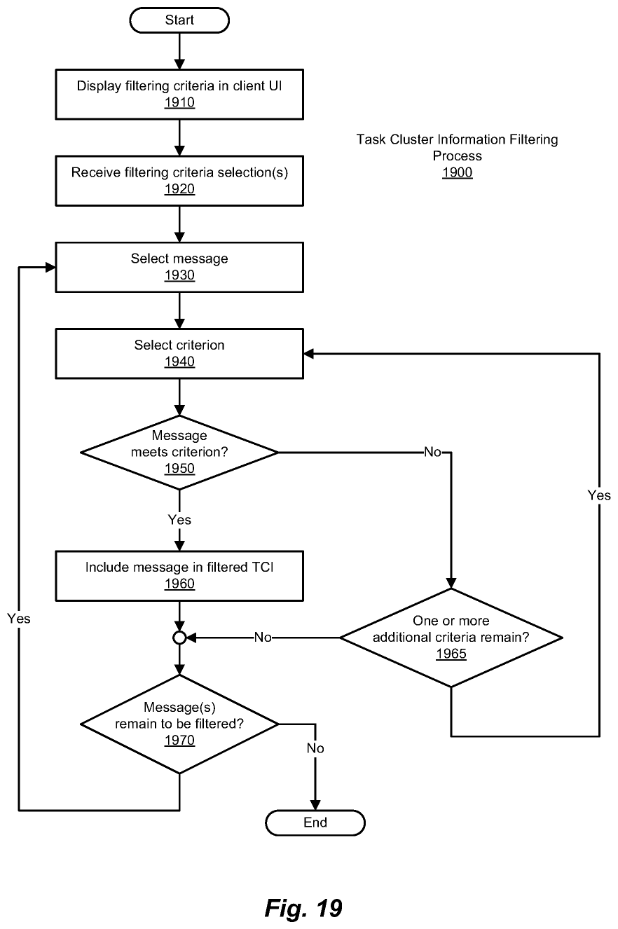

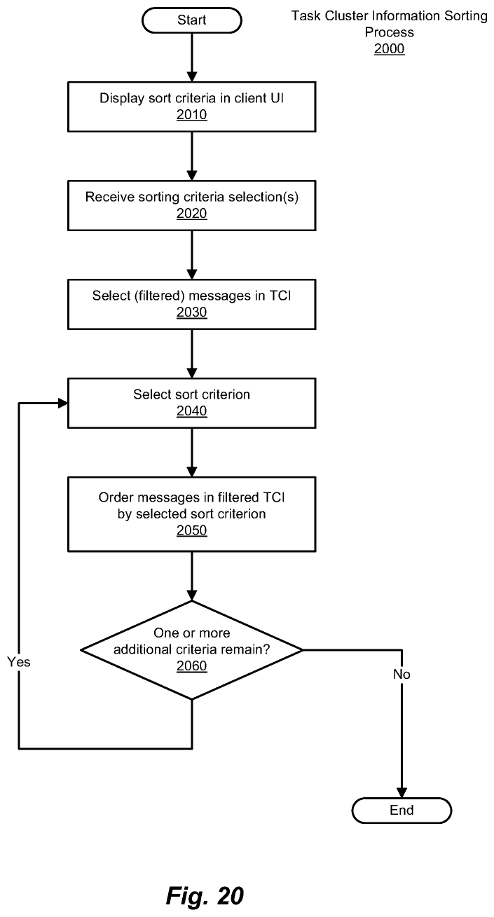

Upon receipt of the TCI in question, a determination is made as to whether filtering is to be performed on the TCI (1840). If filtering is to be performed on the TCI received, such filtering is then performed (1845). An example of such TCI filtering is discussed in connection with FIG. 19, subsequently. Once the TCI in question has been filtered (or a determination that no such filtering is needed has been made), a determination is then made as to whether the (filtered) TCI is to be sorted (1850). If the (filtered) TCI is to be sorted, a process for sorting the (filtered) TCI is performed (1855). An example of such TCI sorting is discussed in connection with FIG. 20, subsequently. Once the (filtered) TCI has been sorted (or a determination that no such sorting is desired), the (sorted) (filtered) TCI is displayed in the client UI (1860).

A determination is then made as to whether the TCI displayed should be updated (1865). If the TCI displayed is to be updated, a process for updating the TCI is performed (1870). Once the displayed TCI has been updated (if so indicated), client process 1800 proceeds to a determination as to whether client process 1800 should conclude (1875). In the case in which client process 1800 is to continue, client process 1800 loops to awaiting receipt of the next message(s) (1810). In the alternative, client process 1800 concludes.

FIG. 19 is a flow diagram illustrating an example of a task cluster (TC) information filtering process, according to methods and systems such as those disclosed herein. That being the case, a task cluster information filtering process 1900 is depicted. Task cluster information filtering process 1900 begins with the display of filtering criteria in the client user interface (1910). One or more filtering criteria selections for them received (1920). One or more messages are then selected in the TCI question (1930). One of the filtering criteria is then selected (1940). A determination is then made as to whether the selected message meets the given criterion (1950). If the given message meets the criterion, the message is included in the filtered TCI (1960). In the alternative if the messaging question does not meet the given criterion, a determination is made as to whether one or more additional criteria remain (1965). If further criteria remain, task cluster information filtering process 1900 loops to the selection of the next criterion (1940).

If the given message is included in the filtered TCI or does not meet criteria in question, task cluster information filtering process 1900 proceeds to a determination as to whether one or more messages remain to be filter (1970). If further messages remain to be filtered, task cluster information filtering process 1900 loops to the selection of the next message (1930). In the alternative, task cluster information filtering process 1900 concludes.

FIG. 20 is a flow diagram illustrating an example of a task cluster information sorting process, according to methods and systems such as those disclosed herein. That being the case, a task cluster information sorting process 2000 is depicted. Task cluster information sorting process 2000 begins with displaying one or more sort criteria in the client UI (2010). One or more sorting criteria selections are then received (2020). The (filtered) messages in the TCI are then selected (2030). One of the selected sort criteria is then selected for use in sorting the messages (2040). Messages are then ordered in the filtered TCI as per the selected sort criterion (2050). A determination is then made as to whether additional sort criteria remain to be used in the sorting of the messages (2060). If further criteria remain to be used in sorting the (filtered) messages, task cluster information sorting process 2000 loops to the selection of the next sort criterion (2040). In the alternative, task cluster information filtering process 1900 concludes.

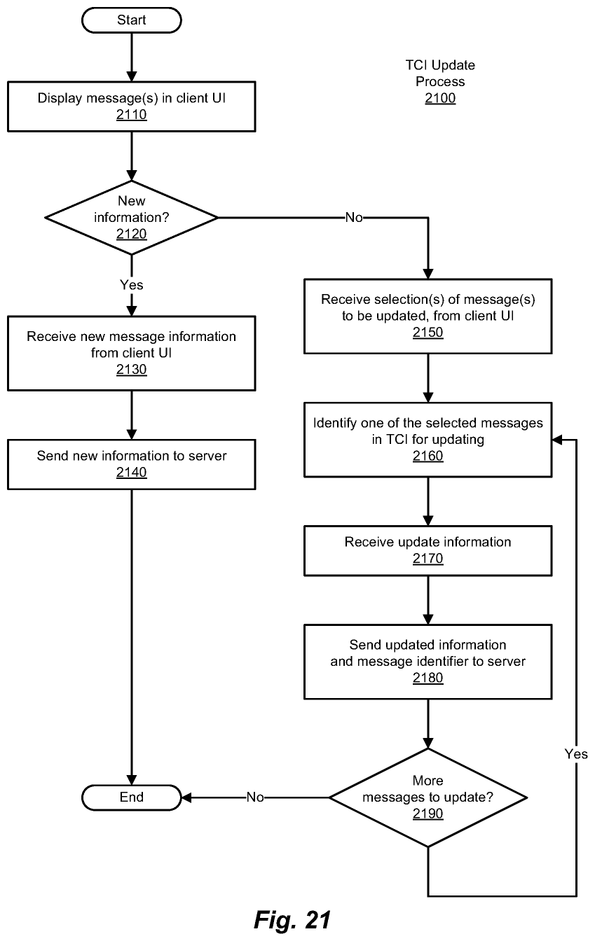

FIG. 21 is a flow diagram illustrating an example of a task cluster information update process, according to methods and systems such as those disclosed herein. That being the case, a task cluster information update process 2100 is depicted. As will be appreciated from the present disclosure, task cluster information update process 2100 reflects operations that may be performed on a client device, in order to send an update (update information) to a server, and so instruct the server to update the affected task cluster information. Task cluster information (TCI) update process 2100 begins with the display of one messages in the client user interface (UI), as displayed on the user's client device (2110). Input from the user is then received, and a determination as to whether new information is presented is made (2120). In the case in which new information is to be received, TCI update process 2100 proceeds with the receipt of new message information, as received from the client UI (130). The new message information thus received is then sent to the appropriate server (2140). TCI update process 2100 includes.

In the alternative, if the determination as to new information (2120) indicates that the selection is not intended for the receipt of information, TCI update process 2100 proceeds with receiving, from the client UI, one or more selections one or more messages that are to be updated (2150). One or more message selections having been received, one of the selected messages in the TCI is identified for updating (2160). Update information for the identified message of the selected messages is then received via the client (2170). The update information having been received, update information and a message identifier (identifying a message) are sent to the appropriate server (2180). The update information and message identifier having been sent, a determination is made as to whether additional messages remain to be updated (2190). In the case in which further messages remain to be updated, TCI update process 2100 loops to the identification of another of the selected messages (2160). Alternatively, in the case in which no further messages are to be updated, TCI update process 2100 concludes.

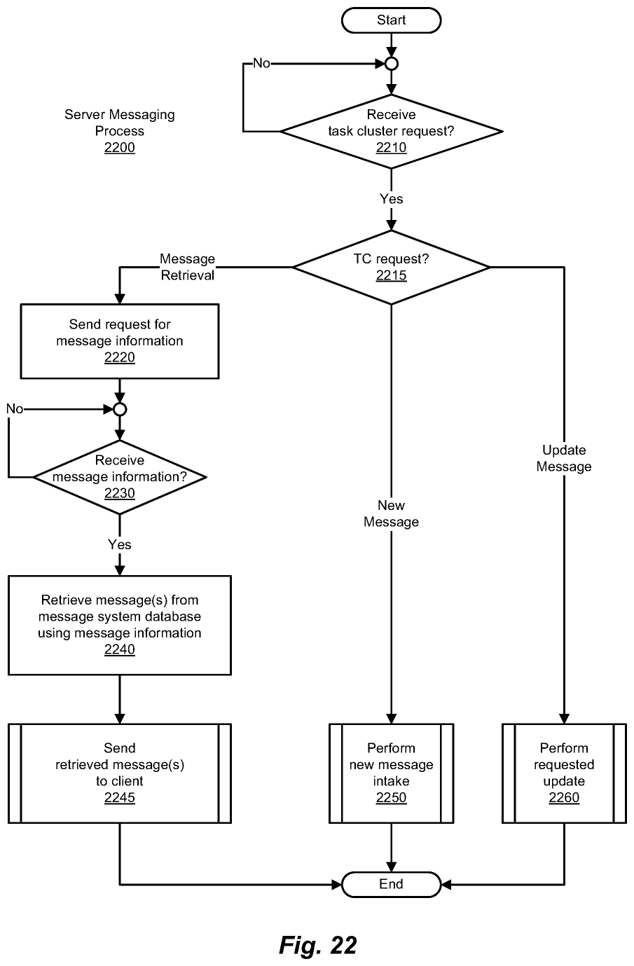

FIG. 22 is a flow diagram illustrating an example of a server messaging process, according to methods and systems such as those disclosed herein. That being the case, a server messaging process 2200 is depicted. Server messaging process 2200 begins with awaiting receipt of a task cluster (TC) request (2210). Server messaging process 2200 iterates at this juncture, awaiting receipt of a TC request. Once a TC request received, the server in question then determines the type of TC request that the server has received (2215). Examples of such request types include a message retrieval request, new message request, and an update message request. As will be appreciated in view of the present disclosure, a server performing a process such as server messaging process 2200 can implement other TC message types, and such other TC message types are contemplated hereby.

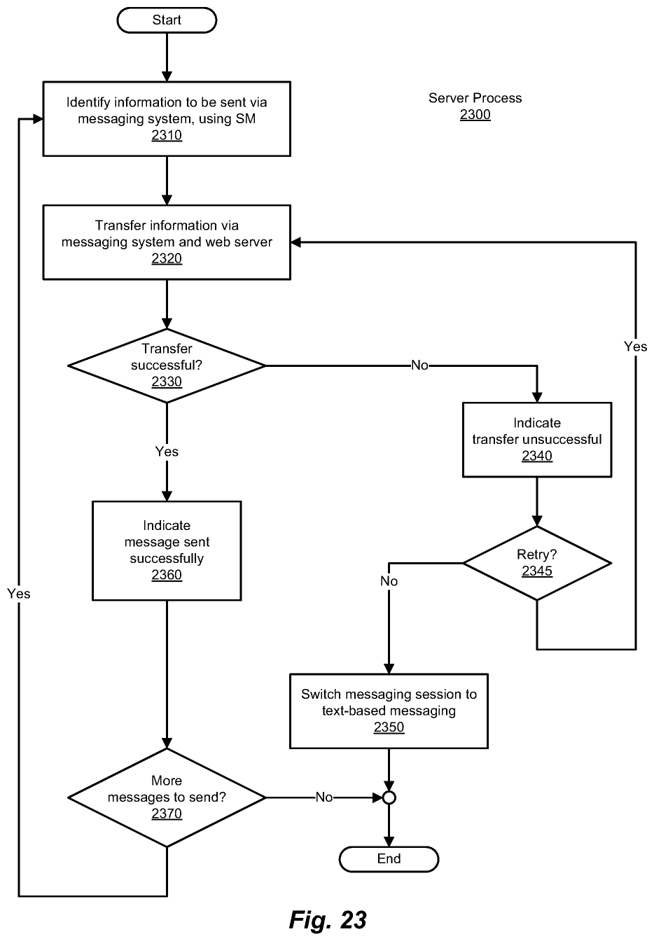

If the TC message type is a message retrieval request, a request for message information is sent (e.g., to a database management system tasked with maintaining messages of the messaging system) (2220). Server process 2200 then iterates, awaiting receipt of message information (2230). Once the requisite message information is been received, the server in question proceeds with retrieving one or more messages from the messaging system database, using the message information received (2240). Messages thus retrieved are then sent to the requesting client (2245). A process for sending the retrieved messages to the requesting client is described in greater detail in connection with FIG. 23, subsequently. Server messaging process 2200 then concludes.

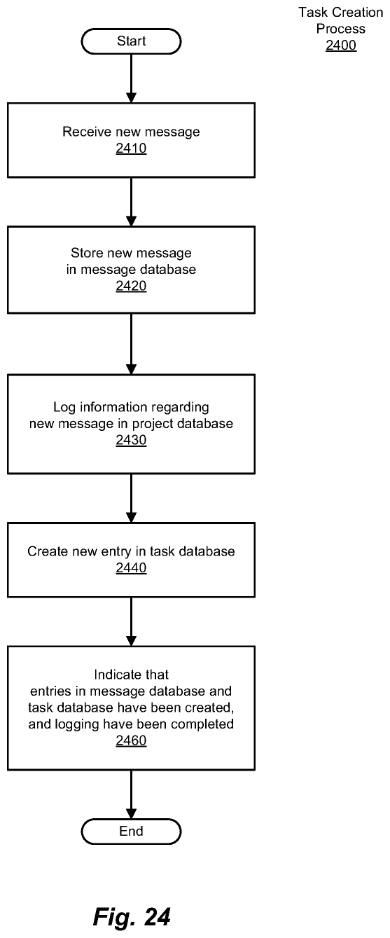

Alternatively, if the TC request type is a new message request, the server in question performs new message intake (2250). Such new message intake can include receiving one or more messages, and storing such messages in the messaging system database. A process for performing new message intake is described in greater detail in connection with FIG. 24, subsequently. Server messaging process 2200 then concludes.

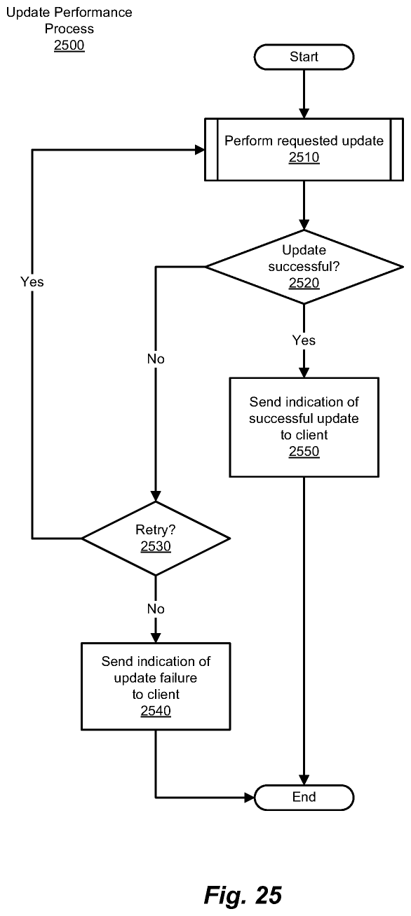

In another alternative, TC request type received may be an update message request. In such case, server messaging process 2200 proceeds with performing one or more requested updates to the affected task clusters (2260). A process for updating the TC information, as per the update message request received, is described in greater detail in connection with FIG. 25, subsequently. Server messaging process 2200 then concludes.

FIG. 23 is a flow diagram illustrating an example of a server process, according to methods and systems such as those disclosed herein. That being the case, a server messaging process 2300 is depicted. As noted in connection with the preceding discussion of FIG. 22, server messaging process 2300 is performed in response to a message retrieval request received by the server from a client, once the requisite messages have been retrieved.

Server messaging process 2300 thus begins with the messaging system performing processing to identify the message(s) to be sent via the messaging system to the client (2310). Having identified the messages to be provided to the client, the messages (or access thereto) are transferred from the server to the messaging system (for further transmission, possibly through one or more web servers, to the requesting client) (2320).

A determination is then made as to whether the message(s) were successfully transferred from the server to the messaging system (2330). If the transfer was unsuccessful, an indication that the transfer was unsuccessful is provided to, for example, the messaging system (e.g., for presentation to one or more of the users involved in the messaging session) (2340). Once this indication is provided, a determination is then made (2345) as to whether the messaging system should restart the process, in an attempt to successfully transfer the message(s) from the server to the messaging system, or in the alternative, to switch the messaging session to text-only messaging (2350). In the latter case, the messaging session continues, albeit without using the tagging facilities provided by methods and systems such as those described herein. As will be appreciated in light of the present disclosure, the switch to text-based messaging can indicate that only the tag in question will not be employed, or that the messaging session will use text-based messaging from that point forward (or until some condition is met). If another attempt to transfer the message is to be made, server messaging process 2300 loops back to identifying the message(s) to be sent via the messaging system (2310). However, if the messaging session is to switch to text-based messaging (2350), any operations requisite to switching to such text-based messaging are performed, such that the messaging session can proceed on a text-based messaging basis, and the process (at least with respect to the given tags) concludes.

As will be appreciated in light of the present disclosure, the messaging session can proceed in a number of ways at this point, including switching to text-based messaging for the remainder of the messaging session. Alternatively, the messaging system can indicate the situation, ignore the given tags, allow for text-based messaging, and then attempt to support subsequent transfers of further messages using. These and other such alternatives are intended to be within the scope of embodiments such as those described herein.

If the transfer of the messages to the messaging system is successful (2330), an indication is made to this effect (2360). A determination is then made as to whether further messages remain to be sent (2370). If further messages remain to be sent, server process 2300 iterates to the identification of information to be sent via the messaging system, and proceeds (2310). In the alternative, server messaging process 2300 concludes.

FIG. 24 is a flow diagram illustrating an example of a task creation process, according to methods and systems such as those disclosed herein. That being the case, a task creation process 2400 is depicted. As noted in connection with the preceding discussion of FIG. 22, task creation process 2400 is performed in response to a new message request being received by the server from a client. Man being the case, task creation process 2400 is performed, for example, as part of the intake of a new task message (e.g., the receipt and processing of a message that results in not only the communication of the message's content, but also the inclusion of information associated therewith in the program management information maintained as part of the messaging system).

Task creation process 2400 begins with the receipt of a new message (2410). Task creation process 2400 then proceeds with storing the new message in a message database (2420). Such storage can be accomplished, for example, by inserting a new row into a message table such as message table 1340, along with the requisite information such as that described in connection therewith. Next, log information regarding the new message can be stored in a project database (2430). This can be accomplished by inserting a new row into a project task log such as project task log table 1510, as well as inserting information into, potentially, a project table such as project table 1410 and/or inserting information in a task table such as task table 1430.

Next, a new entry in any affected task databases can be inserted (2440). Here again, this operation can be effected by inserting a new row into a project task log such as project task log table 1510, as well as inserting information into, potentially, a project table such as project table 1410 and/or inserting information in a task table such as task table 1430. An indication that the requisite entries in the message database and task database(s) have been created, and the requisite logging has been completed (2450). Task creation process 2400 then concludes. As will be appreciated in light of the present disclosure, the order in which the foregoing operations are described is for purposes of example only. That being the case, the order in which such operations are performed can be altered, with equally good effect.

FIG. 25 is a flow diagram illustrating an example of an update performance process, according to methods and systems such as those disclosed herein. That being the case, an update performance process 2500 is depicted. As noted in connection with the preceding discussion of FIG. 22, update performance process 2500 is performed in response to a update message request being received by the server from a client.

Update performance process 2500 begins with performing the requested update (2510). Examples of processes for performing such update operations are described in greater detail in connection with FIGS. 26 and 27, subsequently. A determination is then made as to whether the update operation was successful (2520). If the update operation was not successful, update performance process 2500 proceeds to a determination as to whether the update operation should be retried (2530). If the update operation should be retried, update performance process 2500 loops and retries performing the requested update (2510). In the alternative, if the update operation will not be retried (e.g., a certain number of attempts have already been made), update performance process 2500 sends an indication of update failure to the client (2540). Update performance process 2500 then concludes.

Alternatively, if the update was successful (2520), update performance process 2500 sends an indication of a successful update operation to the client (2550). Update performance process 2500 then concludes.

FIG. 26 is a flow diagram illustrating an example of a server task update process, according to methods and systems such as those disclosed herein. That being the case, a server task update process 2600 is depicted. It will be appreciated that server task update process 2600 presents examples of operations performed by a server in updating single-table changes (e.g., such as changes to times/dates for certain tasks).

Server task update process 2600 begins with the receipt of a message indicating that task information for a given task should be updated (2610). As described earlier, the new message is stored in the appropriate mask database (2620). Such storage can be accomplished, for example, by inserting a new row into a message table such as message table 1340, along with the requisite information such as that described in connection therewith. Also as before, information regarding the new message is logged in the appropriate project database(s) (2630). Here again, this can be accomplished by inserting a new row into a project task log such as project task log table 1510, as well as inserting information into, potentially, a project table such as project table 1410 and/or inserting information in a task table such as task table 1430.

Next, the server identifies the entry in the task database to be updated (2640). This can be accomplished, in certain embodiments, by identifying the appropriate row in the given task table (e.g., such as task table 1430). The server then edits the subject entry in the task database using the message information in the message (e.g., by editing the information the appropriate row of task table 1430) (2650). At this juncture, previous task entry/entries in the task database can be edited to reflect changes resulting in the subject entry in the task database from the aforementioned changes to the initial entry (2660). Similarly, subsequent task entry/entries in the task database can be edited to reflect changes resulting in the subject entry in the task database from the aforementioned changes to the initial entry (2670). It will be further appreciated in light of the present disclosure that such propagation of changes in either direction from the initial entry can continue throughout the project's entries. One such propagation is complete, server task update is 2600 concludes.

FIG. 27 is a flow diagram illustrating an example of a server task information update process, according to methods and systems such as those disclosed herein. That being the case, a server task information update process 2700 is depicted. It will be appreciated that server task information update process 2700 presents examples of operations performed by a server in updating multiple-table changes (e.g., such as may be the case in situations in which changes multiple projects/tasks (e.g., a given individual is no longer available as a team member for the given projects/tasks to which that individual was assigned)).

Server task information update process 2700 begins with the receipt of a message indicating that task information for a given task should be updated (2710). As described earlier, the new message is stored in the appropriate mask database (2720). Such storage can be accomplished, for example, by inserting a new row into a message table such as message table 1340, along with the requisite information such as that described in connection therewith. Also as before, information regarding the new message is logged in the appropriate project database(s) (2730). Here again, this can be accomplished by inserting a new row into a project task log such as project task log table 1510, as well as inserting information into, potentially, a project table such as project table 1410 and/or inserting information in a task table such as task table 1430.

Next, the server identifies the entry in the affected tables in the task database to be updated (2740). This can be accomplished, in certain embodiments, by identifying the appropriate row in the given task table (e.g., such as task table 1430). In certain embodiments, the affected tables can be identified using the message type of the message received. In certain situations, messages affecting multiple tables can include payment messages (affecting, e.g., task payment table 1460), bid modification messages (affecting, e.g., task payment table 1460), budget modification messages (resulting in a change to budget field 1435, and so affecting, e.g., task table 1430), and other such situations.

The server then edits the subject entries in the affected tables of the task database using the message information in the message (e.g., by editing the information the appropriate row of task table 1430) (2750). At this juncture, as before, previous task entry/entries in the task database can be edited to reflect changes resulting in the subject entries of the various tables of the task database from the aforementioned changes to the initial entries (2760). Similarly, subsequent task entry/entries in the task database can be edited to reflect changes resulting in the subject entries of the various tables of in the task database from the aforementioned changes to the initial entries (2770). It will be further appreciated in light of the present disclosure that such propagation of changes in either direction from the initial entry can continue throughout the project's entries. One such propagation is complete, server task information update is 2700 concludes.

### Example Program Management Workflows

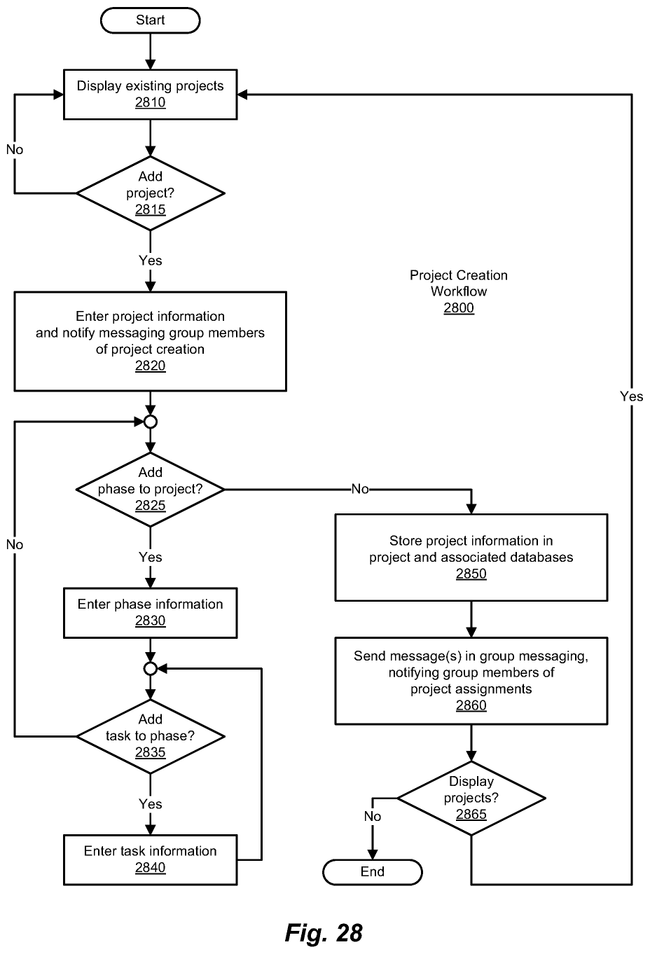

FIG. 28 is a workflow diagram illustrating an example of a project creation workflow, according to methods and systems such as those disclosed herein. That being the case, a project creation workflow 2800 is depicted. It is to be appreciated that the examples of program management workflows discussed in this portion of the disclosure are intended to be examples of the operations in the use of a client user interface that a member or other individual might execute in such a user interface, in order to interact with a messaging system such as that described herein.

Project creation workflow 2800, in the example depicted in FIG. 28, begins with the display of existing projects (2010). It will be appreciated that such display can be in the form of a list of projects, a map with markers indicating projects (and optionally, information regarding those projects), or in some other suitable fashion. A determination is then made as to whether the user would like to add a project (2815). If no such indication is made, project creation workflow 2800 iterates, awaiting such instruction. Upon the receipt of such instruction, project creation workflow 2800 proceeds to receiving the entry of project information and notifying messaging group members of the project's creation (2820).

At this juncture, the user may add a phase to the project (2825). If the user will add a phase to the project, the user enters phase information (2830). A determination is then made as to whether the user would like to add a task to the phase in question (2835). In the case in which no tasks are to be added to the phase (e.g., because the user has already added the desired tasks to the phase) project creation workflow 2800 loops to making a determination as to whether another phase should be added to the project (2025). In the alternative, the user enters task information (2040). Project creation workflow 2800 thus iterates, allowing the user to add some number of tasks to the phase in question. Once the desired tasks have been added, project creation workflow 2800 iterates to the determination as to whether another phase is to be added to the project (2025).

At this point, once the desired phases have been added to the project, project creation workflow 2800 proceeds to storing the project information in the project and associated databases (2850). One or more messages are then sent using the messaging system to members of the project's group using group messaging, and notifying the group's members of their project assignments (2860). It will be appreciated that, in fact, while it may be advantageous to apprise group members of their responsibilities with respect to a given project in a single message or group of messages, a messaging system such as that described herein can, in the alternative, notify members of their membership in a given project and the assignment of their responsibility with respect to phases/tasks of that project as those phases/tasks are created. A determination is then made as to whether the user desires to return to the display of existing projects (2865). If so, project creation workflow 2800 returns to displaying existing projects (2810). In the alternative, project creation workflow 2800 concludes.

FIG. 29 is a workflow diagram illustrating an example of a task processing workflow, according to methods and systems such as those disclosed herein. That being the case, a task processing workflow 2900 is depicted. Task processing workflow 2900 begins with the selection, by user, of a project in a group messaging screen (2910). The user then requests and receives budget information in that group messaging screen (2915). A determination is then made as to whether the budget received is approved (2920). If the budget is not approved, a determination is made as to whether budget revision is allowed (2925). If budget revisions are not allowed (or a maximum number of budget revisions has been reached), task processing workflow 2900 concludes, and the user is no longer allowed to make budget revisions. In that case, task processing workflow 2900 concludes. However, in the alternative, if budget revisions are allowed, the user can enter revised budget information (2930). Task processing workflow 2900 then loops to the point at which the user can request/receive budget information in the group messaging screen (2915).

In the alternative, if the budget is approved, an indication of approval is sent in the messaging group via the messaging system (2940). One or more tasks of the project can then be assigned in the messaging group (2945). A determination is then made as to whether any tasks have been completed, as indicated by the receipt of a completion message in the messaging group (2950). If no such indication has been received, task processing workflow 2900 iterates.

Upon receipt of a completion message in the messaging group, a determination is made as to whether further tasks remain to be completed (2955). If further tasks remain to be completed, task processing workflow 2900 iterates to awaiting receipt of the next task completion message (2950). In the alternative, task processing workflow 2900 proceeds to the creation of one or more folders and their association with the given program/project/phase/task (or other program division/subdivision) (2965). For example, association with the given project/phase/task and the folder(s) created can be accomplished by creating one or more folders for the given project/phase/task by using identifying information for the project/phase/task (e.g., the names of the given project/phase/task) in generating a folder pathname, into which data (e.g., files, data objects, URLs, and other such units of information storage) can be uniquely stored. Once the requisite folder(s) have been created, project data can be uploaded (stored in) those folder(s) (2965). Task processing workflow 2900 can then conclude.

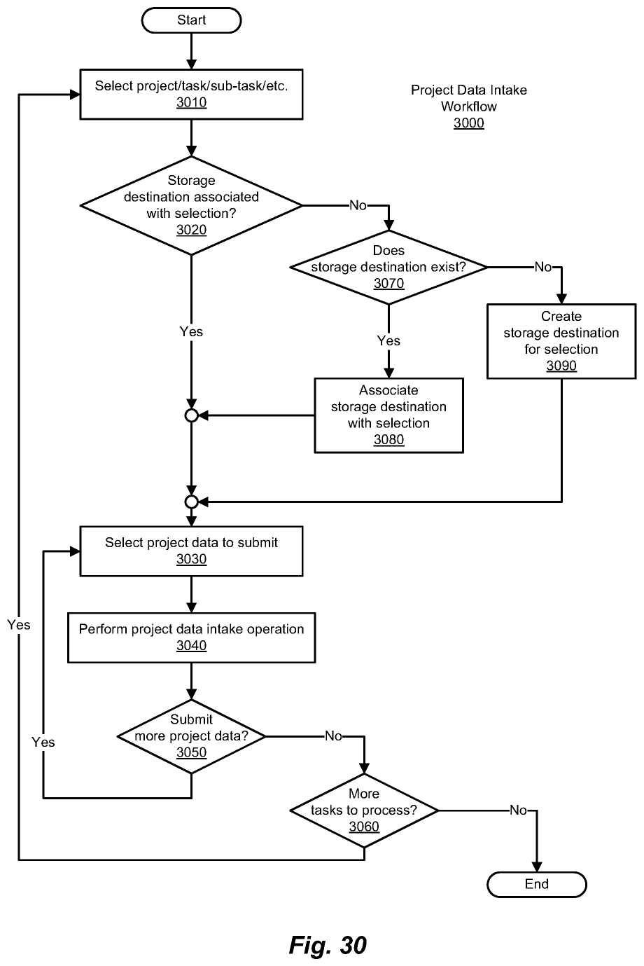

FIG. 30 is a workflow diagram illustrating an example of a project data intake workflow, according to methods and systems such as those disclosed herein. That being the case, a project data intake workflow 3000 is depicted. It will be appreciated that, in light of the present disclosure, such a project data intake workflow can be performed to upload (store) project data on the initial creation of the project, and updating a project's information, or in other situations in which project data is to be presented to and stored by the messaging system.

Project data intake workflow 3000 can begin with the selection of the project, task, subtask, or the like for which project data is to be stored (3010). A determination is then made as to the storage destination of the project data to be stored (3020). If the storage destination can be identified based on information regarding the project/task/subtask, the user can then select the project data to submit (3030). A project data intake operation is then performed (3040). Such a project data intake operation can be the storage of one or more files (e.g., image data, video data, audio data, or other such data as may be convenient to represent information regarding the project/task/subtask, whether that be the state thereof, materials therefor, or other such information as may be pertinent to the project/task/subtask). A determination is then made as to whether further project data is to be the subject of additional project data intake operations (3050). If further project data remains to be uploaded, project data intake workflow 3000 proceeds with the selection of the next project data to be submitted (3030). In the alternative, a determination is made as to whether further projects/tasks/subtasks remain to be processed (3060). If the user indicates that further projects/tasks/subtasks remain to be processed, project data intake workflow 3000 proceeds with the selection of the next project/task/subtask (3010). In the alternative, project data intake workflow 3000 concludes.

Returning now to the determination as to the storage destination being associated with the given project/task/subtask selected (3020), if the storage destination in question is not indicated with regard to the given project/task/subtask, project data intake workflow 3000 makes a determination as to whether the storage destination in question exists (e.g., as by searching for such a destination and/or requesting information regarding the destination from the user) (3070). If the storage destination in question exists, project data intake workflow 3000 associates this storage destination with the selected project/task/subtask (3080). Project data intake workflow 3000 then proceeds as described above. In the alternative, if the storage destination for the selected project/task/subtask does not exist, project data intake workflow 3000 proceeds with the creation of this storage destination for the selected project/task/subtask (3090). Project data intake workflow 3000 again proceeds as described above.

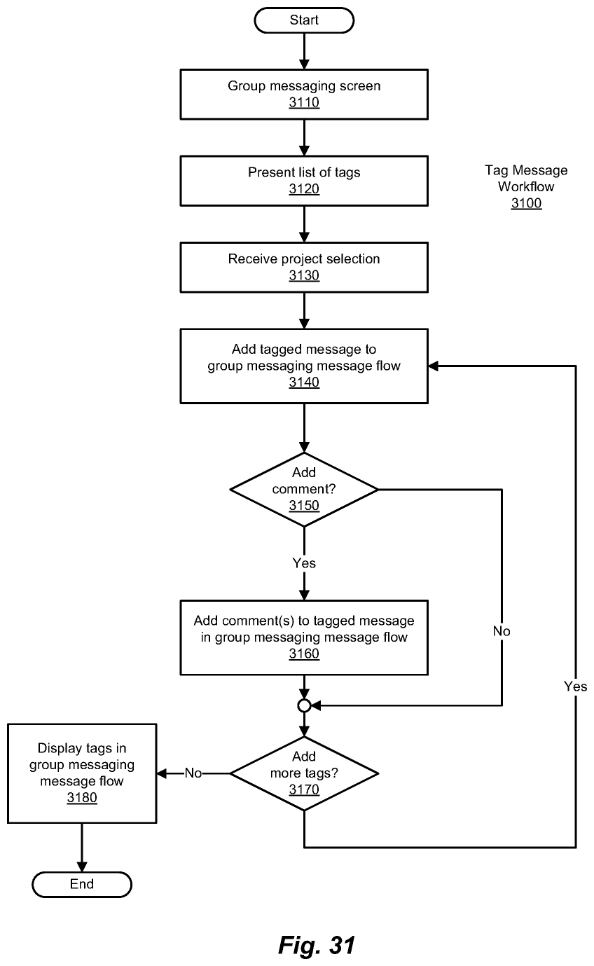

FIG. 31 is a workflow diagram illustrating an example of a tag message workflow, according to methods and systems such as those disclosed herein. That being the case, a tag message workflow 3100 is depicted. A user is presented with a group messaging screen to begin tag message workflow 3100 (3110). By, for example, selecting a message in the group messaging screen, a user can be presented with a list of tags with which to tag the messaging question, for example (3120). It is to be appreciated that, in light of the present disclosure, such tags can be new or existing tags, associated with a given project/task/subtask, or find use such as an association between a given tag and any meaningful aspect of a program or its components might prove advantageous to an organization or any group of individuals.

Once presented with the list of tags in the group messaging screen, the user can provide a project selection to the messaging system, which receives the project selection (3130). At this juncture, the user is able to add a tag message to the group messaging message flow (3140). At this juncture in tag message workflow 3100, the user is able to add a comment, as well (3150). If the user indicates that they would like to add a comment, tag message workflow 3100 proceeds with allowing the user to add the comment to the tag message in the group messaging message flow (3160). One such a comment has been added (or no such comment is desired (3150)), a determination is made as to whether the user desires to add additional tags (3170). In the case in which the user indicates a desire to add additional tags, tag message workflow 3100 loops to the operation in which a tagged message is added to the group messaging message flow (3140). In the alternative, the desired tags having been added, tag message workflow 3100 proceeds with displaying the tags thus added in the group messaging message flow (3180). At this point, tag message workflow 3100 can conclude. One

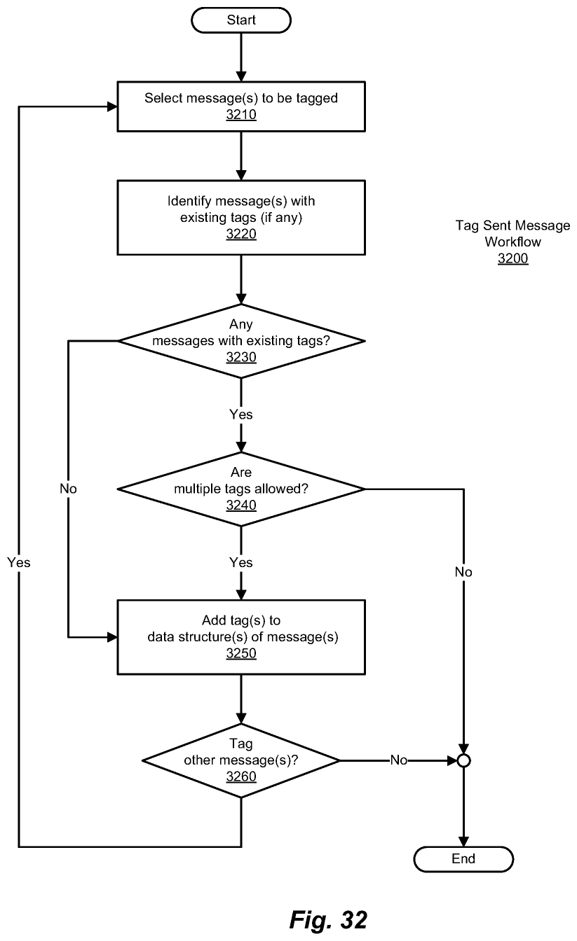

FIG. 32 is a workflow diagram illustrating an example of a tag sent message workflow, according to methods and systems such as those disclosed herein. That being the case, a tag sent message workflow 3200 is depicted. Tag sent message workflow 3200 begins with the selection of one or more messages to be tagged (3210). Next, any messages with existing tags are identified (although messages with existing tags may not exist for the given program subdivision) (3220). A determination is then made as to whether any messages with such existing tags can be identified (3230). If messages with multiple existing tags are identified, a determination is made as to whether multiple tags are allowed (3240). If multiple tags are not allowed, tag sent message workflow 3200 concludes.

If no messages with existing tags are identified or multiple tags are allowed in such cases, the user can then add one or more tags, which results in the adding of such tags to the data structures of the messages in question (3250). A determination is then made as to whether the user indicates a desire to tag other messages (3260). In the case in which the user wishes to tag other messages, tag sent message workflow 3200 loops to the users selection of the next message to be tagged (3210). In the alternative, tag sent message workflow 3200 concludes.

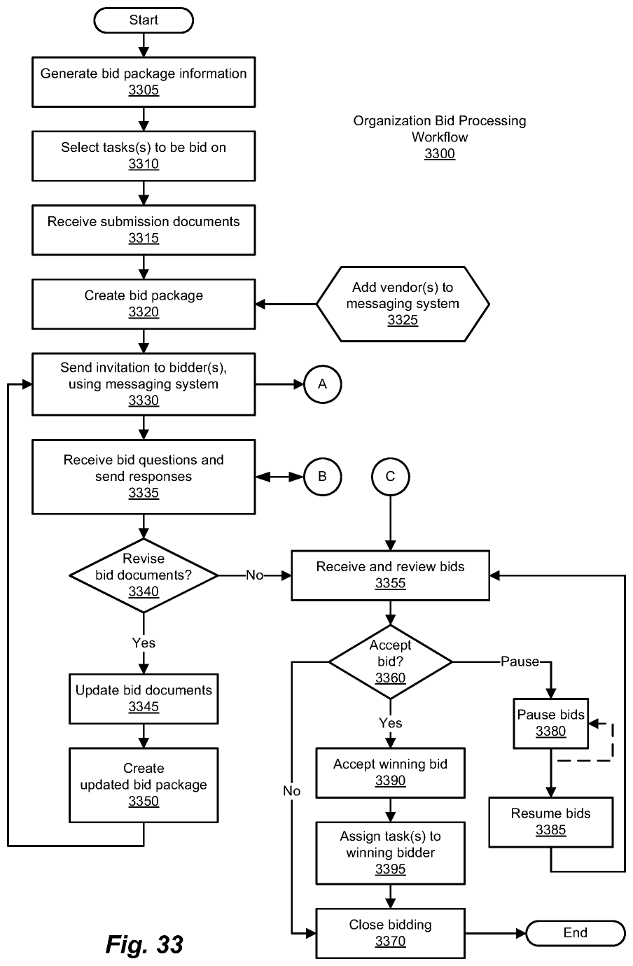

FIG. 33 is a workflow diagrams illustrating an example of an organization bid processing workflow, according to methods and systems such as those disclosed herein. That being the case, organization bid processing workflow 3300 is depicted. Organization bid processing workflow 3300 begins with the user or organization generating a bid package information (3305). The selection of one or more tasks to be bid on can then be received (3310). Submission documents can also be received (3315), and a bid package created (3320). To this end, the organization can add one or more vendors to the messaging systems databases, in order to allow those vendors to bid various jobs presented via the messaging system (e.g., in messages to one or more such vendors via the messaging system) (3325).

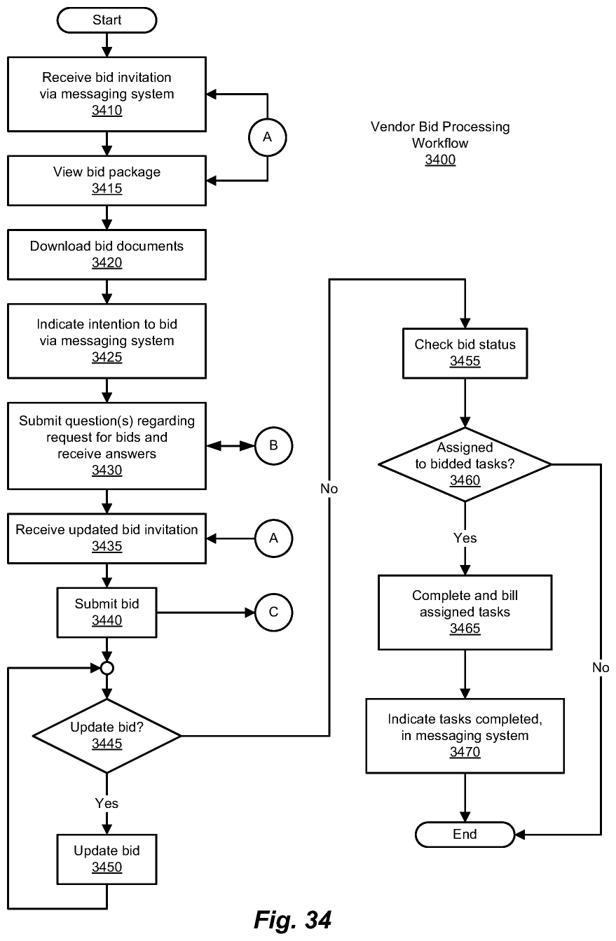

Next, invitations to one or more bitters can be sent using the messaging system (3330). As is depicted in FIG. 33 by connector “A”, this sending of invitations results in the receipt of such invitations by the vendors in question, as is described in further detail in connection with FIG. 34, subsequently. The organization can then receive bid questions from the invited vendors and send responses to those invited vendors, in response to those questions (3335). Here again, the interaction between the organization and the vendors is indicated by the connector “B” in FIGS. 33 and 34.

Once the vendors have presented their questions and the organization has sent its responses, organization bid processing workflow 3300 proceeds to a determination as to whether the bid documents will be revised (3340). In the case in which the organization will revise the bid documents, the bid documents are updated (3345) and an updated bid package is created (3350). Organization bid processing workflow 3300 then resends invitations to the vendors, so that they may submit revised bids based on the updated bid package (3330). Organization bid processing workflow 3300 then proceeds through the operations described above.

In the event that the bid documents will not be revised (or have been revised to the extent the organization is willing to revise them) (3340), organization bid processing workflow 3300 proceeds to the receipt and review of bids from the vendors (3355). Here again, the interaction between the organization and the vendors is indicated by the connector “C”, in the manner described earlier.

At this juncture, a determination is made as to whether one (or more) of the received bids will be accepted (3360). In the event that the organization does not find any of the bids thus received acceptable, the organization can close bidding, and so reject all bids received (3370). Organization bid processing workflow 3300 then concludes.

In the alternative, the organization may choose to pause bidding, and so indicate to the vendors involved (3380, until such time that the organization decides to resume bids (3385). However, should the organization decide to accept one or more of the bids (either directly or after one or more pauses), the organization proceeds to accepting the one or more bids by way of organization bid processing workflow 3300 (3390). Having accepted the bid(s), the organization goes about assigning various tasks/subtasks or the like to the vendor(s) in question (3395), and closes bidding (3370). Organization bid processing workflow 3300 then concludes.

FIG. 34 is a workflow diagram illustrating an example of a vendor bid processing workflow, according to methods and systems such as those disclosed herein. That being the case, a vendor bid processing workflow 3400 is depicted. As is indicated by connector “A”, vendor bid processing workflow 3400 begins with receipt of a bid invitation via the messaging system (3410), at which point the vendor is able to view the bid package for the project/task/subtasks in question (3415). Next, the vendor is able to, via the messaging system, download bid documents for the bid package in question (3420). After having reviewed the bid documents, the vendor is then able to indicate their intention to bid on the project/task/subtasks via the messaging system (3425). It will be appreciated that this juncture that the addition of vendors noted in connection with FIG. 33 illustrates the organization's control over the bidding process via the addition of vendor users to, for example, a group messaging session in the messaging system.

At this juncture, the vendor is able to submit one or more questions regarding the bid documents and other information associated with the request for bids, as well as receiving answers to those questions, via the messaging system, as is indicated by connector “B” (3430). If the organization is amenable to updating the bid documents (and so the bid package), the vendor will be able to receive an updated bid invitation, as is indicated by connector “A” (3435). The vendor can then submit their bid via the messaging system, as is indicated by connector “C” (3440). Further, and again if the organization is amenable, the vendor may be able to update their bid (3445). If such is the case, the vendor proceeds with updating their bid as they may feel is necessary (3450), and vendor bid processing workflow 3400 returns to the determination as to updating bids (3445).

Once the vendor has updated their bid (or no further such updates are allowed), vendor bid processing workflow 3400 proceeds with the vendor being able to check the status of their bid via the messaging system (3455). The vendor is then able to make a determination as to whether one or more of the projects/tasks/subtasks on which the vendor bid, have been assigned to that vendor (3460). In the case in which none of the project blast asks for that on the vendor bid has been toward the vendor, vendor bid processing workflow 3400 concludes.

In the alternative, if one or more projects/tasks/subtasks the bid assigned to the vendor (3460), the vendor can then complete the assigned projects/tasks/subtasks, and build their efforts to the organization (3465). The vendor can indicate that these projects/tasks/subtasks have been completed using the messaging system (3470). In fact, in certain embodiments, the vendor can use the messaging system to submit invoices to the organization. Vendor bid processing workflow 3400 then concludes.

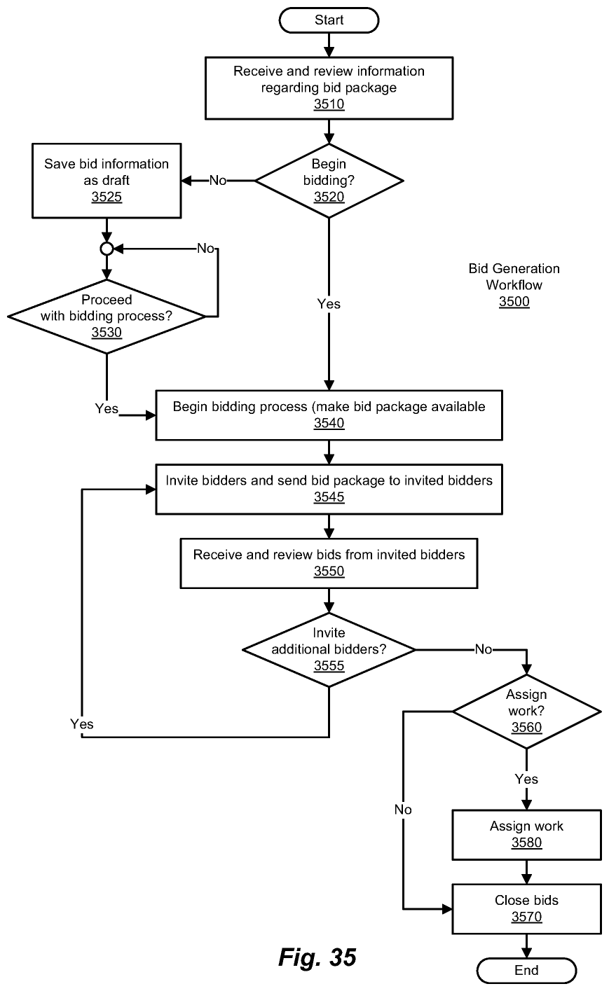

FIG. 35 is a workflow diagram illustrating an example of a bid generation workflow, according to methods and systems such as those disclosed herein. That being the case, a ration workflow 3500, as might be performed by an individual associated with an organization sending out a project, task, subtasks, or other such program subdivision for bid, is depicted. Bid generation workflow 3500 begins with the receipt and review of information regarding a bid package (3510). A determination is then made as to whether the bid package is in a state that will allow bidding to begin (3520). If further information and/or revision is determined to be necessary, a user following bid generation workflow 3500 can proceed to saving the bid information as a draft (3525). The user can leave the bid information in a draft state until such time as the user is ready to proceed with the bidding process (3530). It will be appreciated, in light of the present disclosure, that, as part of determining whether or not to proceed, such a user is able to review and revise the draft bid information until such time as the user decides that the bid information is sufficient to proceed with the bidding process.

Once the bid information is in an appropriate state (or was determined to be, and so the bidding process would begin at the outset (3520)), the bidding process is begun by, for example, making the bid package available (3540). The vendors are then invited to submit their bids (3545). The organization then receives and reviews bids from the invited bidders (3550). Should the organization so decide, a determination is made as to whether additional bidders will be invited (e.g., in the case in which the vendors originally invited to bid have not submitted any acceptable bids) (3555). If additional bidders are to be invited, bid generation workflow 3500 loops to making such invitations to additional vendors and sending those vendors the bid package (in its then-current state), via the messaging system (3545).

In the alternative, once the desired vendors have been invited and have submitted their bids, the organization can then make a determination as to whether any of those bids are acceptable, and the work in question can be assigned (3560). In the case in which the organization does not find any of the bids acceptable, bidding can simply be closed (3570), and thus reject those bids. In such case, bid generation workflow 3500 concludes. Alternatively, if the organization finds one or more of the bids acceptable, the working question can be assigned (3580). Here again, bidding is then closed (3570), and bid generation workflow 3500 concludes.

### Example Program Management Workflows

The following discussions describe various example message types. In describing these examples, interactions between various of the tables in a syntactic marker database system schema and operations performed on such tables is described. The following discussions provide examples of commands that can be triggered via the functionalities provided, for example, the SDK described earlier and JSON-formatted (JSON being Java Script Object Notation, as noted earlier) messages such as those described below, to create specialized updates in specific tables within a database structure such as syntactic marker database system schema 1200. To this end, in the manner noted, examples of the tables of syntactic marker database system schema 1200 are presented in connection with FIGS. 13-16, such that user table 1210 (e.g., user table 1310), session member table 1215 (e.g., session member table 1320), conversation table 1220 (e.g., conversation table 1330), message table 1225 (e.g., message table 1340), project table 1230 (e.g., project table 1410), task table 1235 (e.g., task table 1430), project task member table 1240 (e.g., project task member table 1440), task bid table 1250 (e.g., task bid table 1420), task payment table 1255 (e.g., task payment table 1460), data table 1260 (e.g., data table 1450), project task log table 1270 (e.g., project task log table 1510), and syntactic marker table 1280 (e.g., syntactic marker table 1610) are described.

In one embodiment, a user may want to locate a task of a project (of a program) in a chronological feed of a task cluster. For example, a user needs to quickly review information for a task that is being referenced in a chat message. In certain embodiments of a messaging system according to the present disclosure, syntactic markers are presented as hyperlinks in the graphical user interface, and so can be selected/followed (are “clickable”) through the use of a message format such as JSON or XML. When a user selects the hyperlink, libraries of the software development kit search the appropriate database table(s) (e.g., syntactic marker table 1280), and provide information to the GUI to present as information related to the given database cluster of information associated with the given syntactic marker (also referred to herein as a “task cluster”). From such a syntactic marker table, the functionality provided by the SDK is able to identify the unique task identifier to identify the appropriate information to present to the user (e.g., taking the user to a landing web page that presents the desired information to the user). Using the information identified in syntactic marker table 1280, the functionality provided by the SDK examines the relevant table (e.g., project task log table 1270) to examine the interactions that have occurred relative to that respective task for which the user is searching.

The list of communications related to a task (also referred to herein as the “feed” of a task) can have both messages sourced from conversations related to the task between users, as well as specific messages associated with (also referred to herein as the such messages being “pinned” to the task), such that users are able to post such messages to the given conversation and/or associate messages with that conversation. The messages can be differentiated from one another by the “Message ID Column” (highlighted in Table 1, below). Thus, in certain embodiments, when the Message ID is a 0, then the message is a message in a messaging session, and, also in certain embodiments, does not cause any actions to be taken by the messaging system.

TABLE 1
Project task log example table.

| Log | | Project | Task | Message | Message | | Message |
|---|---|---|---|---|---|---|---|
| Identifier | Log Date | Identifier | Identifier | Identifier | Type | Status | Information |
| 1 | MM/DD/YYYY | 1 | 2 | 2 | DELAY | ACCEPTED | 0 |
| | HH:MM:SS | | | | | | |
| 2 | MM/DD/YYYY | 5 | 3 | 3 | PAYMENT | PENDING | 0 |
| | HH:MM:SS | | | | | | |
| 3 | MM/DD/YYYY | 7 | 4 | 0 | CONVERSATION | 0 | Message |
| | HH:MM:SS | | | | | | Body |
| 4 | MM/DD/YYYY | 8 | 2 | 5 | BID | ACCEPTED | 0 |
| | HH:MM:SS | | | | | | |
| 5 | MM/DD/YYYY | 11 | 1 | 7 | CHECK IN | PENDING | 0 |
| | HH:MM:SS | | | | | | |

In this regard, it will be appreciated that project task log table 1510 (as reflected in Table 1, above) provides for the logging of information regarding the messages and events managed via a messaging system according to the present disclosure, and their relationship(s) to the various projects and tasks managed thereby. Example processes for creating and maintaining such tables are described in connection with FIGS. 17-27, as previously discussed. As will be appreciated in light of the present disclosure, additional columns can be included in project task log table 1510 to provide for other delineations (programs, subtasks, phases, and other such divisions/subdivisions). In the alternative, a single column can be used and project/task/subtask identifiers combined (e.g., as by concatenation into a predefined format) into a global identifier. Further still, such global identifiers can be generated by hashing such information (in whatever suitable order is preferred) to produce a token that uniquely identifies the combination of project, task, subtask, and/or the like.

Thus, a project task log table such as that represented in Table 1 (e.g., project task log table 1270, more specifically depicted as project task log table 1510) maintains information that, in certain embodiments, includes information identifying the log entry and date thereof, project and tasks identifiers of the project and task to which the message is related, the message identifier of the message, the type of message (the message's message type, indicating one (or more) effects the message may have on a project, task, subtask, or the like), such an action's status (if an action is associated with the message), and message information (if the message in question includes information). That being the case, Table 1, in certain embodiments, includes information regarding the project (e.g., a project identifier), a task (e.g., a task identifier), and a message (e.g., a message identifier). As noted, such a project identifier can act as a link to a project table (e.g., such as project table 1230, an example of which is project table 1410). Similarly, such a task identifier can act as a link to a task table (e.g., such as task table 1235, an example of which is task table 1430). The message identifier in the project task log entry can act as a link to a message table (e.g., such as message table 1225, an example of which is message table 1340). Such linkages are examples of the associations noted earlier herein.

In one embodiment, the tables of a database system such as database system 805 are referenced and modified when new messages are communicated that include one or more syntactic markers. For example, a user can search for a task and its respective syntactic marker(s) using a mobile device application's or web application's graphical user interface. Such functionality can be provided, for example, via a software development kit (SDK) such as that described in connection with software development kit 920. Functionality within SDK 920 can then refer to syntactic marker table 1280 (e.g., syntactic marker table 1610) in the database (e.g., a database such as database system 805, implementing syntactic marker database system schema 1200) to search for the syntactic markers (and so, tasks) relevant to the users communicating with regard to the task. The user then selects the desired syntactic marker, in order to be added into the conversation in question.

The user then sends a specific message which triggers the SDK to insert rows into both message table 1225 (e.g., message table 1340) and project task log table 1270 (e.g., project task log table 1510). The row inserted into message table 1340 contains the specific message, while the row in project task log table 1510 includes a reference to project task log table 1510 that identifies messages relevant to that task conversation (i.e., a conversation related to the task in question, within the messaging system). Rows may also be inserted into other tables or existing rows updated, depending on the message type. If the message in question has associated media, files, or the like (referred to generically herein as “data”), project task log table 1270 (e.g., project task log table 1510) is also edited to include a reference to one or more entries.

The effects of a given message being sent is reflected in the “Message Type” column of a project task log table such as project task log table 1510, for example (and highlighted in the “Message Type” column of Table 2, below). Within project task log table 1510, the “Message Type” column indicates the type of message communicated via the messaging system. These different message types are types of messages that can trigger SDK 920 to perform actions in addition to inserting information into message table 1340 and project task log table 1510. Using such techniques, users have increased flexibility to indicate and document the progress of projects and tasks by way of sending messages via the messaging system.

TABLE 2
Project task log example table highlighting message type information.

| Log | | Project | Task | Message | Message | | Message |
|---|---|---|---|---|---|---|---|
| Identifier | Log Date | Identifier | Identifier | Identifier | Type | Status | Information |
| 1 | MM/DD/YYYY | 1 | 2 | 2 | DELAY | ACCEPTED | 0 |
| | HH:MM:SS | | | | | | |
| 2 | MM/DD/YYYY | 5 | 3 | 3 | PAYMENT | PENDING | 0 |
| | HH:MM:SS | | | | | | |
| 3 | MM/DD/YYYY | 7 | 4 | 0 | CONVERSATION | 0 | Message |
| | HH:MM:SS | | | | | | Body |
| 4 | MM/DD/YYYY | 8 | 2 | 5 | BID | ACCEPTED | 0 |
| | HH:MM:SS | | | | | | |
| 5 | MM/DD/YYYY | 11 | 1 | 7 | CHECK IN | PENDING | 0 |
| | HH:MM:SS | | | | | | |

An example of a message type that results in modifications to the messaging system database is a time modification message type. In one embodiment, such a message could be one that modifies the start time or end time of the task (as is described in connection with, for example, FIGS. 18, 19, 20, 22, and 23, above). One example of this message type would be a delay on a task or a project (an example of which is the entry in Table 2 with Log Identifier “1” and Message Type of “DELAY”). With this message type, the logic of the software development kit (e.g., SDK 920) is triggered to not only insert rows into message table 1340 (e.g., at Message Identifier “2”) and project task log table 1510 (e.g., at Log Identifier “1”), but also to edit specific information in task table 1430 (as is shown in Table 3, below).

Function(s) in the software development kit identify the specific row of task table 1430 and edits the date stored in the end date column (highlighted in Table 3, below) for the entry of the row corresponding to the task identified by the users' message (Message Identifier “2”). Such functionality can also result in the modification of information regarding multiple tasks, if there are other tasks related to that task (e.g., the tasks, if any, identified in “Preceding Task Identifier” and “Subsequent Task Identifier” columns). In the present example, the message identified by Message Identifier “2” is associated with the task identified by Task Identifier “2” (and the project identified by Project Identifier “1”). As can be seen in task table 1430 of syntactic marker tables 1400 in FIG. 14A, task “2” is preceded by task “1” (as is depicted in the relevant task identifier in preceding task field 1437) and is followed by task “3” (as is depicted in the relevant task identifier in subsequent task field 1438).

TABLE 3
Task table example table for messaging information.

| | | | | | | | Preceding | Subsequent |
|---|---|---|---|---|---|---|---|---|
| Task | Project | Task | Start | End | | Task | Task | Task |
| Identifier | Identifier | Name | Date | Date | Budget | Information | Identifier | Identifier |
| 1 | 1 | TASK | MM/DD/YY | MM/DD/YY | $$$ | Task | 0 | 2 |
| | | 1 | | | | information | | |
| 2 | 1 | TASK | MM/DD/YY | MM/DD/YY | $$$ | Task | 1 | 3 |
| | | 2 | | | | information | | |
| 3 | 1 | TASK | MM/DD/YY | MM/DD/YY | $$$ | Task | 2 | 4 |
| | | 3 | | | | information | | |

In this regard, it will be appreciated that task table 1430 (as reflected in Table 3, above) provides for the maintenance of information regarding the tasks managed via a messaging system according to the present disclosure. As noted, task table 1430 (as reflected in Table 3) includes linkages to other tables, which are examples of the associations created to promulgate and maintain program management information between users and within the program management databases of the messaging system.

To that end, it can be seen that a project identifier in Table 3 links that entry (for the given task) to the appropriate entry in the associated project table (e.g., such as project table 1230, an example of which is project table 1410).

Relevant task information is depicted as being maintained in task information field 1436 of each task's task table entry. This information can include any information deemed relevant to the given task and not provided for elsewhere (or more efficiently stored in task information field 1436, with respect to storage efficiency, efficiency of database accesses, and/or the like). Further, task information field 1436 can comprehend multiple such fields, as efficiency and/or ease-of-use may dictate.

It will also be appreciated that task table 1430 is self-referential (e.g., as demonstrated by way of preceding task field 1437 and subsequent task field 1438). Such constructs allow traversal of the task's dependency chain, in order to propagate the effects of a given event (e.g., as might result from the receipt of a message with a DELAY message type, as depicted in FIG. 15 as the entry in project task log table 1510 having a log entry identifier of 1). These types of fields can also be used to represent dependency trees of projects/tasks/subtasks/etc. (with multiple preceding/subsequent tasks identified, depending on the relationships between those tasks), as well as within given projects, tasks, subtasks, and the like (e.g., parent/child dependency relationships, as well as sibling relationships). By maintaining information regarding such relationships and associations, changes to tasks can be propagated through the given program, and in so doing, automatically update related/associated tasks and the like, in order to automatically maintain information regarding such tasks in a timely and efficient manner. Further, a user is able to search for and identify tasks, subtasks, and so on, related to the program, project, or the like, using syntactic markers. A user can thus identify which such tasks, subtasks, and the like will be affected by a given action (or which have been affected by a given action), and the effects that such an event would have on the tasks, subtasks, etc., thus identified, allowing the user to determine the effects of such an event and the possible outcomes thereof. Such functionality provides a powerful tool in managing a program, project, or the like.

Further, such programs, projects, tasks, subtasks, and the like, as well as combinations thereof, can be identified by using tokens. Such a token can be generated, for example, by hashing the names of such programs/projects/etc. or other information related thereto. The use of tokens in such implementations can be advantageous with regard to the improved security such tokens provide, as well as potential improvements in storage and efficiency for the messaging database. In the former case, information regarding such hashes (e.g., the has function employed, the specific information hashed (including information regarding the project, the members, etc.), and other such information) can be determined on, for example, a project-by-project (or task-by-task) basis, thereby maintaining confidentiality and security as between those projects and tasks (or tasks within a given project). In certain embodiments, such hashing is implemented using a one-way hash, such that entries, event, users, and so on can only be confirmed as existing, occurring, being associated with, and so on. Such an implementation would further enhance security by allowing a user to access only the requested item, and not necessarily information regarding other projects, tasks, or the like. Further, such an implementation can prevent a given user from being able to determine relationships between other projects, tasks, or the like.

Moreover, particularly for large programs (and so, relatively large numbers of projects, tasks, subtasks, users, messages, and so on), the ability to provide such security while reducing the size of such secure information is advantageous with respect to efficient communication and storage of such information, as well as improving the efficiency of database operations. While the generation of such tokens may involve additional computational resources (e.g., as when using a one-way hash each time a given entry or the like is to be accessed), the smaller amount of data communicated, stored, and processed results in an overall improvement in the operations of a secure messaging system such as that described herein.

Another example of a message type that results in modifications to the messaging system's databases is a payment modification message. In one embodiment, such a message may be one that triggers payments to another user (or their organization, such as a vendor) based on an interaction on a specific task (as is described in connection with FIGS. 21, 25, 26, and 27, above). One example is the completion of the task. In that case, a messaging system such as that described herein automates both edits on the end time of the task and also payment for work performed on the task (e.g., by the vendor). In this message type, the software development kit's business logic is triggered to not only insert rows into message table 1340 and project task log table 1510, but also to insert information or edit information in task payment table 1460 (an example of which appears as Table 4, below). For example, such a message can trigger a third-party Automated Clearing House (ACH) payment processor, in order to send digital payments to a user such as a vendor. As before, entries in Table 4 are linked to their respective tasks (in this case, by an entry being identified with a given task identifier).

TABLE 4
Task payments table example.

| Payment | Task | | | |
|---|---|---|---|---|
| Identifier | Identifier | Total | Processed | Balance |
| 1 | 2 | $100.00 | $0.00 | $100.00 |
| 2 | 3 | $200.00 | $100.00 | $100.00 |
| 3 | 4 | $300.00 | $150.00 | $150.00 |
| 4 | 2 | $1000.00 | $500.00 | $500.00 |
| 5 | 1 | $1200.00 | $800.00 | $400.00 |

Yet another example of a message type that results in modifications to the messaging system's databases is a bid modification message. In one embodiment, such a message is one that solicits bids from multiple users (as is described in connection with FIGS. 21, 25, 26, and 27, as well as FIGS. 33, 34, and 35, above). In this message type, the software development kit's business logic is triggered to not only insert rows into message table 1340 and project task log table 1510, but also to edit specific information into the appropriate entry of task bid table 1420 (as is reflected in Table 5, below).

TABLE 5
Task bid table example.

| Bid | Message | | Task | |
|---|---|---|---|---|
| Identifier | Identifier | Private | Identifier | Bid Info |
| 1 | 0 | Y | 2 | $100.00 |
| 2 | 5 | N | 3 | $200.00 |
| 3 | 7 | Y | 4 | $300.00 |

Linkage to a given message in message table 1340 is identified by the message identifier associated with the given entry in task bid table 1420, which links that entry to the appropriate message (e.g., such as is maintained in message table 1225, an example of which is message table 1340). Similarly, the task with which the message is associated is identified by the task identifier stored in the entry of task bid table 1420, which links that entry to the appropriate task (e.g., such as is maintained in task table 1235, an example of which is task table 1430).

Still another example of a message type that results in modifications to the messaging system database is a budget modification message. In one embodiment, a message could be one that modifies the budget of the project. One example of this message type would be a request for more labor or materials (as is described in connection with FIGS. 25, 26, and 27, as well as FIGS. 33, 34, and 35, above).

In this message type, the business logic of the software development kit is triggered to not only insert rows into message table 1340 and project task log table 1510, but also to edit specific information into task table 1430 (as is reflected in Table 6, below). Here again, the messaging system's software development kit identifies the specific row of task table 1430 and edits budget information the budget column (highlighted Table 6, below) of that specific row, depending on the budget information in the users' message.

TABLE 6
Task table example.

| | | | | | | | Preceding | Next |
|---|---|---|---|---|---|---|---|---|
| Task | Project | Task | Start | End | | Task | Task | Task |
| Identifier | Identifier | Name | Date | Date | Budget | Information | Identifier | Identifier |
| 1 | 2 | TASK | MM/DD/YY | MM/DD/YY | $$$ | INFO | 0 | 2 |
| | | 1 | | | | | | |
| 2 | 3 | TASK | MM/DD/YY | MM/DD/YY | $$$ | INFO | 1 | 3 |
| | | 2 | | | | | | |
| 3 | 4 | TASK | MM/DD/YY | MM/DD/YY | $$$ | INFO | 2 | 4 |
| | | 3 | | | | | | |

Linkage to a given message in message table 1340 is identified by the message identifier associated with the given entry in task table 1430, which links that entry and the appropriate message(s) to one another (e.g., such as is maintained in message table 1225, an example of which is message table 1340). Similarly, the project with which the message is associated is identified by the project identifier stored in the entry of task table 1430, which links that entry to the appropriate project (e.g., such as is maintained in project table 1230, an example of which is project table 1410). Further, as noted elsewhere herein, the task information regarding each task is maintained in the task information column (e.g., task information field 1436), which can, in fact, be divided into multiple columns, each for a given piece of such information.

An example of a message type that results in the creation of a program, project, task, subtask, or the like in the messaging system's databases is a task creation message. In one embodiment, such a message is one that creates tasks for a specific project (as is described in connection with FIGS. 25, 26, and 27, as well as FIGS. 31 and 32, above). In a message of this message type, the software development kit's business logic is triggered to not only insert rows into message table 1340 and project task log table 1510, but also to insert a row into task table 1430 by creating a new task (as is reflected in Table 7, below). In Table 7, the task identified by task identifier 4 (highlighted in Table 7, below) has been insert by such a task creation message.

TABLE 7
Task table example.

| | | | | | | | Preceding | Next |
|---|---|---|---|---|---|---|---|---|
| Task | Project | Task | Start | End | | Task | Task | Task |
| Identifier | Identifier | Name | Date | Date | Budget | Info | Identifier | Identifier |
| 1 | 1 | TASK | MM/DD/YY | MM/DD/YY | $$$ | INFO | 0 | 2 |
| | | 1 | | | | | | |
| 2 | 1 | TASK | MM/DD/YY | MM/DD/YY | $$$ | INFO | 1 | 3 |
| | | 2 | | | | | | |
| 3 | 1 | TASK | MM/DD/YY | MM/DD/YY | $$$ | INFO | 2 | 4 |
| | | 3 | | | | | | |
| 4 | 1 | TASK | MM/DD/YY | MM/DD/YY | $$$ | INFO | 3 | — |
| | | 4 | | | | | | |

An example of the linkages between an entry in task table to the project of which the task is a part is identified by the project's project identifier (e.g., the project identifier stored in the given entry's project identifier field (e.g., project identifier field 1432 of task table 1430)). This project identifier links the task to its project by identifying that project (e.g., such as project table 1230, an example of which is project table 1410). Here again, it will be noted that the task information regarding each task is maintained in the task information column (e.g., task information field 1436), which can, in fact, be divided into multiple columns, each for a given piece of such information.

### An Example Computing and Network Environment

As noted, the systems described herein can be implemented using a variety of computer systems and networks. The following illustrates an example configuration of a computing device such as those described herein. The computing device may include one or more processors, a random access memory (RAM), communication interfaces, a display device, other input/output (I/O) devices (e.g., keyboard, trackball, and the like), and one or more mass storage devices (e.g., optical drive (e.g., CD, DVD, or Blu-ray), disk drive, solid state disk drive, non-volatile memory express (NVME) drive, or the like), configured to communicate with each other, such as via one or more system buses or other suitable connections. While a single system bus is illustrated for ease of understanding, it should be understood that the system buses may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, or the like.

Such CPUs are hardware devices that may include a single processing unit or a number of processing units, all of which may include single or multiple computing units or multiple cores. Such a CPU may include a graphics processing unit (GPU) that is integrated into the CPU or the GPU may be a separate processor device. The CPU may be implemented as one or more microprocessors, microcomputers, microcontrollers, digital signal processors, central processing units, graphics processing units, state machines, logic circuitries, and/or any devices that manipulate signals based on operational instructions. Among other capabilities, the CPU may be configured to fetch and execute computer-readable instructions stored in a memory, mass storage device, or other computer-readable storage media.

Memory and mass storage devices are examples of computer storage media (e.g., memory storage devices) for storing instructions that can be executed by the processors 502 to perform the various functions described herein. For example, memory can include both volatile memory and non-volatile memory (e.g., RAM, ROM, or the like) devices. Further, mass storage devices may include hard disk drives, solid-state drives, removable media, including external and removable drives, memory cards, flash memory, floppy disks, optical disks (e.g., CD, DVD, Blu-ray), a storage array, a network attached storage, a storage area network, or the like. Both memory and mass storage devices may be collectively referred to as memory or computer storage media herein and may be any type of non-transitory media capable of storing computer-readable, processor-executable program instructions as computer program code that can be executed by the processors as a particular machine configured for carrying out the operations and functions described in the implementations herein.

The computing device may include one or more communication interfaces for exchanging data via a network. The communication interfaces can facilitate communications within a wide variety of networks and protocol types, including wired networks (e.g., Ethernet, DOCSIS, DSL, Fiber, USB, etc.) and wireless networks (e.g., WLAN, GSM, CDMA, 802.11, Bluetooth, Wireless USB, ZigBee, cellular, satellite, etc.), the Internet and the like. Communication interfaces can also provide communication with external storage, such as a storage array, network attached storage, storage area network, cloud storage, or the like.

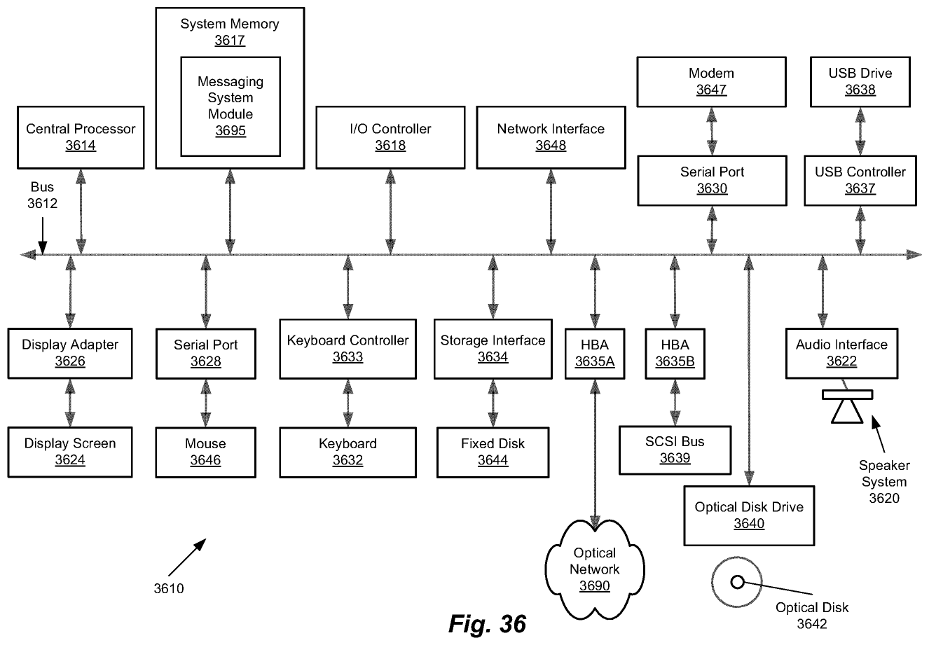

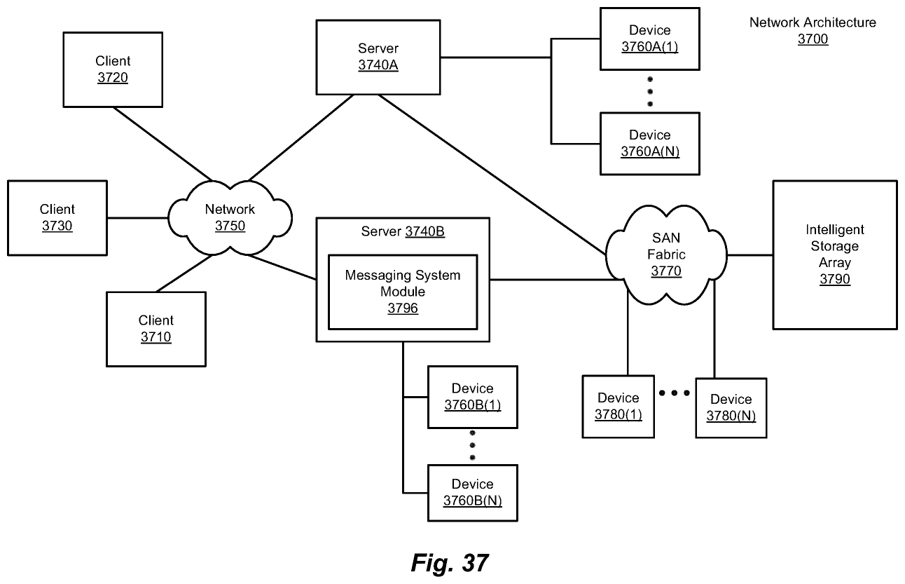

The display device may be used for displaying content (e.g., information and images) to users. Other I/O devices may be devices that receive various inputs from a user and provide various outputs to the user, and may include a keyboard, a touchpad, a mouse, a printer, audio input/output devices, and so forth. The computer storage media, such as memory 504 and mass storage devices, may be used to store software and data, such as, for example, an operating system, one or more drivers (e.g., including a video driver for a display such as display 360), one or more applications, and data. Examples of such computing and network environments are described below with reference to FIGS. 36 and 37.

FIG. 36 depicts a block diagram of a computer system 3610 suitable for implementing aspects of the systems described herein. Computer system 3610 includes a bus 3612 which interconnects major subsystems of computer system 3610, such as a central processor 3614, a system memory 3617 (typically RAM, but which may also include ROM, flash RAM, or the like), an input/output controller 3618, an external audio device, such as a speaker system 3620 via an audio output interface 3622, an external device, such as a display screen 3624 via display adapter 3626, serial ports 3628 and 3630, a keyboard 3632 (interfaced with a keyboard controller 3633), a storage interface 3634, a USB controller 3637 operative to receive a USB drive 3638, a host bus adapter (HBA) interface card 3635A operative to connect with an optical network 3690, a host bus adapter (HBA) interface card 3635B operative to connect to a SCSI bus 3639, and an optical disk drive 3640 operative to receive an optical disk 3642. Also included are a mouse 3646 (or other point-and-click device, coupled to bus 3612 via serial port 3628), a modem 3647 (coupled to bus 3612 via serial port 3630), and a network interface 3648 (coupled directly to bus 3612).

Bus 3612 allows data communication between central processor 3614 and system memory 3617, which may include read-only memory (ROM) or flash memory (neither shown), and random access memory (RAM) (not shown), as previously noted. RAM is generally the main memory into which the operating system and application programs are loaded. The ROM or flash memory can contain, among other code, the Basic Input-Output System (BIOS) which controls basic hardware operation such as the interaction with peripheral components. Applications resident with computer system 3610 are generally stored on and accessed from a computer-readable storage medium, such as a hard disk drive (e.g., fixed disk 3644), an optical drive (e.g., optical drive 3640), a universal serial bus (USB) controller 3637, or other computer-readable storage medium.

Storage interface 3634, as with the other storage interfaces of computer system 3610, can connect to a standard computer-readable medium for storage and/or retrieval of information, such as a fixed disk drive 3644. Fixed disk drive 3644 may be a part of computer system 3610 or may be separate and accessed through other interface systems. Modem 3647 may provide a direct connection to a remote server via a telephone link or to the Internet via an internet service provider (ISP). Network interface 3648 may provide a direct connection to a remote server via a direct network link to the Internet via a POP (point of presence). Network interface 3648 may provide such connection using wireless techniques, including digital cellular telephone connection, Cellular Digital Packet Data (CDPD) connection, digital satellite data connection or the like. Also depicted as part of computer system 3610 is a syntactic message processing module (depicted, e.g., as a messaging system module 3695), which is resident in system memory 3617 and provides functionality and operations comparable to the syntactic message processing and program management processes described earlier herein.

Many other devices or subsystems (not shown) may be connected in a similar manner (e.g., document scanners, digital cameras and so on). Conversely, all of the devices shown in FIG. 36 need not be present to practice the systems described herein. The devices and subsystems can be interconnected in different ways from that shown in FIG. 36. The operation of a computer system such as that shown in FIG. 36 will be readily understood in light of the present disclosure. Code to implement portions of the systems described herein can be stored in computer-readable storage media such as one or more of system memory 3617, fixed disk 3644, optical disk 3642, or USB drive 3638. The operating system provided on computer system 3610 may be WINDOWS, UNIX, LINUX, IOS, or other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 37 is a block diagram depicting a network architecture 3700 in which client systems 3710, 3720 and 3730, as well as storage servers 3740A and 3740B (any of which can be implemented using computer system 3710), are coupled to a network 3750. Storage server 3740A is further depicted as having storage devices 3760A(1)-(N) directly attached, and storage server 3740B is depicted with storage devices 3760B(1)-(N) directly attached. Storage servers 3740A and 3740B are also connected to a SAN fabric 3770, although connection to a storage area network is not required for operation. SAN fabric 3770 supports access to storage devices 3780(1)-(N) by storage servers 3740A and 3740B, and so by client systems 3710, 3720 and 3730 via network 3750. An intelligent storage array 3790 is also shown as an example of a specific storage device accessible via SAN fabric 3770.

Also depicted as part of network architecture 3700 is a syntactic message processing module (depicted, e.g., as a messaging system module 3796 (installed in server 3740B)), which is comparable in function and operation to various of the syntactic message processing and program management processes described earlier herein. For example, using the components depicted in FIGS. 8 and 9, messaging system module 3796 can provide the integrated message processing and program management functionality associated with systems such as those described in connection therewith.

With reference to computer system 3610, modem 3647, network interface 3648 or some other method can be used to provide connectivity from each of client computer systems 3710, 3720 and 3730 to network 3750. Client systems 3710, 3720 and 3730 are able to access information on storage server 3740A or 3740B using, for example, a web browser or other client software (not shown). Such a client allows client systems 3710, 3720 and 3730 to access data hosted by storage server 3740A or 3740B or one of storage devices 3760A(1)-(N), 3760B(1)-(N), 3780(1)-(N) or intelligent storage array 3790. FIG. 37 depicts the use of a network such as the Internet for exchanging data, but the systems described herein are not limited to the Internet or any particular network-based environment.

### Other Embodiments

The example systems and computing devices described herein are well adapted to attain the advantages mentioned as well as others inherent therein. While such systems have been depicted, described, and are defined by reference to particular descriptions, such references do not imply a limitation on the claims, and no such limitation is to be inferred. The systems described herein are capable of considerable modification, alteration, and equivalents in form and function, as will occur to those ordinarily skilled in the pertinent arts in considering the present disclosure. The depicted and described embodiments are examples only, and are in no way exhaustive of the scope of the claims.

Such example systems and computing devices are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

The foregoing thus describes embodiments including components contained within other components (e.g., the various elements shown as components of the computer systems described herein). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation. As such, the various embodiments of the systems described herein via the use of block diagrams, flowcharts, and examples. It will be understood by those within the art that each block diagram component, flowchart step, operation and/or component illustrated by the use of examples can be implemented (individually and/or collectively) by a wide range of hardware, software, firmware, or any combination thereof.

The systems described herein have been described in the context of fully functional computer systems; however, those skilled in the art will appreciate that the systems described herein are capable of being distributed as a program product in a variety of forms, and that the systems described herein apply equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

In light of the foregoing, it will be appreciated that the foregoing descriptions are intended to be illustrative and should not be taken to be limiting. As will be appreciated in light of the present disclosure, other embodiments are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the claims. Variations and modifications of the embodiments disclosed herein can be made based on the description set forth herein, without departing from the scope of the claims, giving full cognizance to equivalents thereto in all respects.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
creating a syntactic marker in a messaging system, wherein
the messaging system comprises a program management database; and
associating the syntactic marker and a messaging communication with one another,
wherein
the messaging communication is sent via the messaging system,
the messaging communication is related to a task of a program,
the associating comprises
updating program management information for the program, and
the program management information is maintained in the program management database.

2. The method of claim 1, further comprising:
associating the syntactic marker and data with one another;
identifying a storage location using the syntactic marker;
storing the data in the storage location; and
sending the messaging communication to a recipient, wherein
the messaging system performs the associating, the identifying, and the storing prior to the recipient receiving the messaging communication.

3. The method of claim 2, further comprising:
creating the storage location using the syntactic marker.

4. The method of claim 3, wherein
the program comprises a project,
the project is identified by a project identifier,
the project comprises the task,
the task is identified by a task identifier, and
the creating the storage location also uses the project identifier and the task identifier.

5. The method of claim 1, wherein
the creating and the associating are accomplished by creating the syntactic marker within the messaging communication.

6. The method of claim 5, further comprising:
presenting the syntactic marker as a hyperlink in a graphical user interface in which the messaging communication is presented by the messaging system.

7. The method of claim 1, wherein the messaging communication is one of one or more messaging communications of a plurality of messaging communications, and the method further comprises:
associating other messaging communications of the one or more messaging communications with the syntactic marker, wherein
the other messaging communications are ones of the one or more messaging communications other than the messaging communication.

8. The method of claim 7, wherein
organizing the plurality of messaging communications into a task feed, using the syntactic marker, wherein
the organizing comprises
identifying the one or more messaging communications of the plurality of messaging communications using the syntactic marker, and
presenting the one or more messaging communications as being associated with the syntactic marker.

9. The method of claim 8, wherein
the task feed is presented in a graphical user interface of the messaging system by presenting the one or more messaging communications in a chronological order.

10. The method of claim 1, further comprising:
assigning the task to a recipient of the messaging communication, wherein
the recipient is assigned the task as a result of the messaging communication being associated with the task by the syntactic marker.

11. A non-transitory computer-readable storage medium, comprising program instructions, which, when executed by one or more processors of a computing system, perform a method comprising:
creating a syntactic marker in a messaging system, wherein
the messaging system comprises a program management database; and
associating the syntactic marker and a messaging communication with one another,
wherein
the messaging communication is sent via the messaging system,
the messaging communication is related to a task of a program,
the associating comprises
updating program management information for the program, and
the program management information is maintained in the program management database.

12. The non-transitory computer-readable storage medium of claim 11, wherein the method further comprises:
associating the syntactic marker and data with one another;
identifying a storage location using the syntactic marker;
storing the data in the storage location; and
sending the messaging communication to a recipient, wherein
the messaging system performs the associating, the identifying, and the storing prior to the recipient receiving the messaging communication.

13. The non-transitory computer-readable storage medium of claim 12, wherein the method further comprises:
creating the storage location using the syntactic marker, wherein
the program comprises a project,
the project is identified by a project identifier,
the project comprises the task,
the task is identified by a task identifier, and
the creating the storage location also uses the project identifier and the task identifier.

14. The non-transitory computer-readable storage medium of claim 11, wherein the messaging communication is one of one or more messaging communications of a plurality of messaging communications, and the method further comprises:
associating other messaging communications of the one or more messaging communications with the syntactic marker, wherein
the other messaging communications are ones of the one or more messaging communications other than the messaging communication; and
organizing the plurality of messaging communications into a task feed, using the syntactic marker, wherein
the organizing comprises
identifying the one or more messaging communications of the plurality of messaging communications using the syntactic marker, and
presenting the one or more messaging communications as being associated with the syntactic marker.

15. The non-transitory computer-readable storage medium of claim 14, wherein the method further comprises:
assigning the task to a recipient of the messaging communication, wherein
the recipient is assigned the task as a result of the messaging communication being associated with the task by the syntactic marker.

16. A computing system comprising:
one or more processors; and
a computer-readable storage medium coupled to the one or more processors, comprising program instructions, which, when executed by the one or more processors,
perform a method comprising
creating a syntactic marker in a messaging system, wherein
the messaging system comprises a program management database; and
associating the syntactic marker and a messaging communication with one another, wherein
the messaging communication is sent via the messaging system,
the messaging communication is related to a task of a program,
the associating comprises
updating program management information for the program, and
the program management information is maintained in the program management database.

17. The computing system of claim 16, wherein the method further comprises:
associating the syntactic marker and data with one another;
identifying a storage location using the syntactic marker;
storing the data in the storage location; and
sending the messaging communication to a recipient, wherein
the messaging system performs the associating, the identifying, and the storing prior to the recipient receiving the messaging communication.

18. The computing system of claim 17, wherein the method further comprises:
creating the storage location using the syntactic marker, wherein
the program comprises a project,
the project is identified by a project identifier,
the project comprises the task,
the task is identified by a task identifier, and
the creating the storage location also uses the project identifier and the task identifier.

19. The computing system of claim 16, wherein the messaging communication is one of one or more messaging communications of a plurality of messaging communications, and the method further comprises:
associating other messaging communications of the one or more messaging communications with the syntactic marker, wherein
the other messaging communications are ones of the one or more messaging communications other than the messaging communication; and
organizing the plurality of messaging communications into a task feed, using the syntactic marker, wherein
the organizing comprises
identifying the one or more messaging communications of the plurality of messaging communications using the syntactic marker, and
presenting the one or more messaging communications as being associated with the syntactic marker.

20. The computing system of claim 19, wherein the method further comprises:
assigning the task to a recipient of the messaging communication, wherein
the recipient is assigned the task as a result of the messaging communication being associated with the task by the syntactic marker.
